(19) United States
(12) Patent Application Publication
(10) Pub. No.: US 2024/0043961 A1
(43) Pub. Date: Feb. 8, 2024

(54) APPARATUS FOR RECOVERY OF BASE METALS FROM GRID METALLICS

(71) Applicant: VERDEEN CHEMICALS INC., Bellevue, WA (US)

(72) Inventors: Vipin Tyagi, Bellevue, WA (US); Amol Harishchandra Naik, Mumbai (IN); Nishchay Chadha, Singapore (SG)

(73) Assignee: VERDEEN CHEMICALS INC., Bellevue, WA (US)

(21) Appl. No.: 17/975,412

(22) Filed: Oct. 27, 2022

Related U.S. Application Data
(63) Continuation-in-part of application No. 17/737,869, filed on May 5, 2022.
Application No. 17/737,869 is a continuation-in-part of application No. 17/567,046, filed on Dec. 31, 2021.

(51) Int. Cl. C22B 3/00; C22B 7/00

(52) U.S. Cl. CPC C22B 13/045; C22B 7/006

(57) ABSTRACT

Disclosed are solutions directed to the recovery of both elemental lead and lead alloy (e.g., antimonial lead) from the grid metallics of recycled LABs. The solutions may comprise in part one or more of the following: a rotating drum for rotationally hammering a mixture comprising the lead paste, the lead alloy, and a solution, wherein the rotational hammering is performed in a manner sufficient to cause the lead paste to no longer physically adhere to the lead alloy; a vessel for receiving the mixture from the drum and vibrating the mixture sufficient to cause material movement within the mixture to facilitate separation of the lead alloy from the lead paste and the solution; and/or a press for pressing the lead alloy into a pressed form. The lead paste recovered in this manner may be further processed to yield pure elemental lead, while the recovered lead alloy may be immediately reused in new battery grids and so forth.

### CROSS-REFERENCE TO RELATED APPLICATION(S)

This application is a continuation-in-part of, claims benefit of and priority to, and incorporates by reference herein in its entirety the following: U.S. patent application Ser. No. 17/737,869, filed May 5, 2022, titled “ELECTROLYTIC EXTRACTION OF ELEMENTAL METAL FROM METAL COMPOUNDS” (Attorney Docket No. AGR2202US1U); which in turn is a continuation-in-part of, and claims benefit of and priority to, U.S. patent application Ser. No. 17/567,046, filed Dec. 31, 2021, titled “ELECTROLYZER WITH HORIZONTAL CATHODE” (Attorney Docket No. AGR2101US1U).

### BACKGROUND

Electrodes in lead-acid batteries (LABs) typically comprise a metallic frame (“grid”) coated with a special lead-based paste (“grid paste” or just “paste”), the former being constructed from a relatively rigid electro-conductive lead alloy (e.g., antimonial lead) while the latter typically comprises lead oxides and lead sulfates coated over the exposed surfaces of the lead-alloy grid. In addition, one or two thin “cloths” may be emplaced over the grid-and-grid-paste combination to promote and maintain even weight distribution. This assembly, with or without cloths, may be herein referred to as an LAB's “grid metallics,” “grid metallics components,” or simply “metallics.”

When the lead alloy and lead paste are recovered and deoxidized together during recycling—which is not uncommon in traditional LAB recycling via smelting (“high temperature reduction”) where the lead paste and the lead alloys are melted and blended together—the resulting output is lead with metallic impurities (up to 2%) due to the presence of the mixed-in alloy material. Because of this impurity, such outputted lead requires extensive additional refining and alloying to recover pure elemental lead and also recreate clean alloy to replace the lead alloy effectively lost in the smelting. As such, recovering elemental lead and clean lead alloy in this manner is both time consuming and energy intensive. Similarly, grid metallics also pose challenges when recycling LABs utilizing electrolytic processes (instead of smelting) because the presence of the lead alloy in the battery paste may also result in the output of impure lead through the electrolytic inefficiencies and/or the continuing presence of the alloying material in the outputted lead.

Therefore, when recycling LABs, it may be desirable to separately recover the lead alloy from the oxidized lead components of the grid metallics prior to deoxidation processing (be it smelting, electrolytics, or other processing). Accordingly, disclosed herein are improved methods and scalable means for enabling the separate but efficient recovery of both oxidized lead (for transformation into pure elemental lead) and lead alloys (such as antimonial lead) from the grid metallics of recycled LABs.

### SUMMARY

Disclosed herein are systems, methods, processes, and/or chemical compositions directed to the recovery of oxidized lead from the grid metallics of recycled LABs, as well as the separate and efficient recovery of the lead alloys thereof. More specifically, various implementations disclosed herein effectively separate lead paste and other lead compounds from the grid metallics such that the resulting “cleaned” grid metallics comprise only the lead alloy grid which may be immediately reused, or re-melted and re-caste as a new lead alloy grid for use, in subsequent manufacturing of new lead batteries. The several and various implementations disclosed herein feature new processes, innovative electrolyzer designs, and/or novel utilization of supplemental chemicals necessary for successful subsequent electrolytic processing of oxidized lead from grid metallics (free of lead alloys from the grid) and thereby transform such oxidized lead into elemental lead while also enabling the recovery of lead alloys for reuse.

Accordingly, various implementations disclosed herein are directed to methods and/or systems for separating lead paste adhering to a lead alloy comprising: mixing the lead paste and lead alloy with a solution to form a mixture; agitating the mixture in a manner sufficient to cause the lead paste to no longer physically adhere to the lead alloy; and removing the lead alloy from the mixture.

For several such implementations: the agitating may comprise rotational hammering of the mixture; the rotational hammering may be achieved at least in part through use of a rotating drum; the rotating drum may comprise internal baffles that at least in part contribute to the rotational hammering; the rate of rotation of the rotating drum may be maintained within a range that is substantially optimal for achieving the rotational hammering of the mixture, and/or that range may be the rate of rotation at which the portions of the mass in the drum are lifted above a medial axis of the drum and subsequently fall back below the medial axis; the mixture may further comprise cloth adhering to the lead paste, and the agitating causes the cloth to no longer adhere to the lead paste or to the lead alloy; the agitating may comprise vibrating a container within which the mixture is contained, said vibration sufficient to cause material movement within the mixture; the container may comprise a sieve through which the solution and the lead paste may pass but through which the lead alloy may not pass; the vibrating of the container at least in part may facilitate passage of the solution and the lead paste through the sieve. Certain implementations may also comprise pressing the lead alloy into a pressed form. For select implementations, the solution may comprise at least one supplemental chemical that at least in part diminishes adherence of the lead paste to the lead alloy.

This summary is provided to introduce a selection of concepts in a simplified form that are further described below in the detailed description. This summary is not intended to identify key features or essential features of the claimed subject matter, nor is it intended to be used to limit the scope of the claimed subject matter, nor is it an admission that any of the information provided herein is prior art to the implementations described herein.

### BRIEF DESCRIPTION OF THE DRAWINGS

The foregoing summary and the following detailed description of illustrative implementations are better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1A is a modified block diagram illustrating the major components of an exemplary end-to-end electro-chemical system for reclaiming near-pure lead from LABs—and indicating directional flow of materials between various subsystems thereof—representative of various implementations disclosed herein;

FIG. 1B is a process flow diagram illustrating an exemplary approach for LAB recycling using the system of FIG. 1A representative of the various implementations disclosed herein;

FIG. 1C is a modified process flow diagram of the process shown in FIG. 1B to further illustrate in more detail the separate processing of the other recyclables and dross processing that are representative of the various implementations disclosed herein;

FIG. 2A is an illustration providing a perspective view of an electrolyzer cell 100 representative of various implementations disclosed herein;

FIG. 2B is an illustration providing a blown-out perspective view of the anode and the interior of the electrolyzer cell of FIG. 2A representative of various implementations disclosed herein;

FIG. 3A is an illustration providing a cut-away side view of the electrolyzer cell of FIG. 2A and FIG. 2B, representative of the various implementations disclosed herein, in an initial ready-to-use configuration for conducting electrolysis;

FIG. 3B is an illustration providing a cut-away side view of the electrolyzer cell of FIG. 2A and FIG. 2B, representative of the various implementations disclosed herein, after being filled with electrolytic materials for electrolysis;

FIG. 3C is an illustration providing a cut-away side view of the electrolyzer cell of FIG. 2A and FIG. 2B, representative of the various implementations disclosed herein, after electrolysis has been performed and liquid components have been drained from the electrolyzing compartment;

FIG. 3D is an illustration providing a cut-away side view of the electrolyzer cell of FIG. 2A and FIG. 2B, representative of the various implementations disclosed herein, after the end product of the electrolysis has been scraped from the horizontal cathode surface and removed from the electrolyzing compartment;

FIG. 4A is an illustration providing a perspective view of a vertical stack of electrolyzer cells representative of various implementations disclosed herein;

FIG. 4B is an illustration providing a perspective view of a lateral line comprising multiple stacks of electrolyzer cells representative of various implementations disclosed herein;

FIG. 4C is an illustration providing a perspective view of a parallel array of multiple lateral lines each comprising multiple stacks of electrolyzer cells representative of various implementations disclosed herein;

FIG. 5A is an annotated chemical illustration of the respective molecular structures for lead monoxide (PbO), lead dioxide (PbO2), and lead hydroxide (Pb(OH)2) (collectively the “oxidized lead components” or “lead oxides”);

FIG. 5B is an annotated chemical illustration of the respective molecular structures for lead sulfate (PbSO4) which, for clarity, is shown with bonding charges and without (that is, with the lead (Pb) atom collocated with the two oxygen atoms having a single bond with the sulfur atom);

FIG. 6A is a partial modified block diagram illustrating the major components of an exemplary washing subsystem, based in part on the system illustrated in FIG. 1A, for recovery of oxidized lead from a non-lead component (NLC) during lead-acid battery (LAB) recycling representative of various implementations disclosed herein;

FIG. 6B is a partial modified process flow diagram illustrating an exemplary washing process, based in part on the approach illustrated in FIG. 1B and FIG. 1C, for recovery of oxidized lead from a non-lead component (NLC) during lead-acid battery (LAB) recycling representative of various implementations disclosed herein;

FIG. 7A is a modified process flow diagram illustrating an exemplary process for separating lead paste adhering to broken lead alloy components to facilitate the recovery of elemental lead from the former and clean lead alloy from the latter in a manner representative of various implementations disclosed herein;

FIG. 7B is a modified block diagram illustrating the major components of an exemplary paste separation unit (PSU) representative of various implementations disclosed herein;

FIG. 7C is a simplified block diagram illustrating a side-cut-away view of the major components of an exemplary alloy separation unit (ASU) representative of various implementations disclosed herein; and

FIG. 8 is a block diagram of an example computing environment that may be used in conjunction with any of the various implementations and aspects herein disclosed.

### DETAILED DESCRIPTION

Elemental metals such as gold, silver, copper, zinc, and lead may be recovered from materials containing these metals by various electrolytic processes (e.g., electrolysis). For example, with regard to recycling lead acid batteries (LABs), the lead paste obtained therefrom (typically comprising portions of pure lead as well as lead monoxide, lead dioxide, and lead sulfate) may be dissolved with or mixed in an electrolyte and the resulting solution or mixture then subjected to electrolytic recovery of pure elemental lead (Pb) at the cathode of an electrolytic device. Similarly, lead dross obtained from such electrolytic processes as well as traditional smelting processes—said lead dross typically comprising portions of pure lead as well as lead monoxide—may be further processed to mechanically remove the pure lead components with the remainder dissolved with or mixed in an electrolyte and the resulting solution or mixture then subjected to electrolytic recovery of pure elemental lead (Pb) at the cathode of an electrolytic device.

However, while conceptually simple and easily implemented on a small scale, the economic recovery of lead from battery paste and its resulting lead dross via electrolytic processes on an industrial scale with sufficient yields and purity and undertaken in an environmentally-friendly manner—as an alternative to existing approaches which require high-temperature smelting—has heretofore been impractical and entirely unachievable. Electrode materials for lead recovery are relatively expensive and operating conditions at the electrodes tend to promote formation of undesirable side products. In existing electrolytic approaches, insoluble lead dioxide frequently forms at the anode, limiting current flow and diminishing operational effectiveness. Likewise, lead produced at the cathode using an acidic electrolyte will deposit as a film on the cathode surface, and this lead can be difficult to remove from the cathode. This deposited lead also re-dissolves into the electrolyte if/when the electric current—that is, the electrical supply performing the electrolysis—is discontinued. Other shortcomings also exist.

Disclosed herein are systems, processes, and chemical compositions for the recovery of elemental metals from impure sources at industrial scales without smelting, and in particular the recovery of elemental lead resulting from recycled LABs (including but not limited to dross produced electrolytic processing, traditional smelting, or any other methodologies that produce lead-containing dross). Although various implementations disclosed herein may be described as specifically pertaining to the recovery of elemental lead from oxidized lead, lead paste, and dross resulting from recycled LABs, such implementations may be equally applied to the recovery of other metals. Accordingly, nothing herein is intended to limit such implementations to lead, lead paste, or lead dross, nor even to just LAB recycling but, instead, the disclosures made herein should be read as broadly as possible as applied to a variety of different metals being extracted from various impure forms and/or recovered from a variety of potentially different sources.

An understanding of various concepts is helpful toward a broader and more complete understanding of the various implementations disclosed herein, and skilled artisans will readily appreciate the implications these various concepts have on the breadth and depth of the various implementations herein disclosed. Certain terms used herein may also be used interchangeably with other terms used herein and such terms should be given the broadest interpretation possible unless explicitly noted otherwise. For example, as used herein the terms electrolysis, electrowinning, and electrorefining should be treated as interchangeable terms such that where one term is used the other terms are also implied, and thus any use of the term electrolysis should be understood to also include electrowinning and electrorefining except where explicitly differentiated. On the other hand, the term “electrolytic processes” is explicitly intended to include and encompass electrolysis, electrowinning, and electrorefining.

Furthermore, as will be readily appreciated and well-understood by skilled artisans, substances that might typically be represented by their chemical compositions using subscripted numbers—such as gaseous oxygen (O₂), water (H₂O), and so forth—may instead be represented herein with regular numbers in lieu of subscripted numbers (i.e., as 02 for gaseous oxygen, H2O for water, and so forth) as the same and equivalent as if subscripted numbers were utilized, and no distinction should be made as to the use of regular numbers versus the use of subscripted numbers anywhere herein.

Electrolytic Processes

As well-known and readily-appreciated by skilled artisans, electrolysis is a technique that uses an electrical direct current (DC) to drive an otherwise non-spontaneous chemical reaction. Using an electrolytic cell, electrolysis can be used to separate elements from one another. More specifically, in an electrolysis process an electrical current—specifically, a direct current (DC)—is passed through an electrolyte to produce chemical reactions at the electrodes and decomposition of the materials in the electrolyte.

The main components required to achieve electrolysis are an electrolyte, electrodes, and an external power source. The electrolyte is a chemical substance which contains free and mobile ions and is capable of conducting an electric current. An electrolyte may be an ion-conducting polymer, a solution, or an ionic liquid compound. For example, a liquid electrolyte may be produced by “salvation,” that is, by the attraction or association of ions of solute with a solvent (such as water) to produce mobile cluster of ions and solvent molecules.

To achieve electrolysis, the electrodes (which are properly connected to a power source) are immersed in an electrolyte but separated from each other by a sufficient distance such that a current flows between them through the electrolyte with the electrolyte completing the electrical circuit. In this configuration, the electrical direct current supplied by the power source attracts ions toward the respective oppositely charged electrodes and drives the non-spontaneous reaction.

Each electrode attracts ions that are of the opposite charge: positively charged ions (“cations”) move towards the electron-providing negatively-charged cathode, and negatively charged ions (“anions”) move towards the electron-extracting positively-charged anode. In effect, electrons are introduced at the cathode (as a reactant) and removed at the anode (as the desired end product). The loss of electrons is referred to as oxidation, and the gain of electrons is referred to as reduction.

Cathodes may be made of the same material as anodes but, typically, are instead made from a more reactive material since anode wear is greater due to oxidation at the anode. Anodes may be made of the same material as cathodes; however, oftentimes anodes are instead made from a less reactive material than the cathode because during electrolysis the wear on the anode is generally greater than the wear on the cathode due to oxidation that occurs at the anode.

When neutral atoms or molecules gain or lose electrons—such as those that might be on the surface of an electrode—they become ions and may dissolve in the electrolyte and react with other ions. Conversely, when ions gain or lose electrons and become neutral, they may form compounds that separate from the electrolyte. For example, positive metal ions may deposit onto the cathode in a layer. Additionally, when ions gain or lose electrons without becoming neutral, their electronic charge is nonetheless altered in the process.

The key process of electrolysis is the interchange of atoms and ions via the addition or removal of electrons resulting from the applied electrical direct current to produce the desired end product (or multiple end products as the case may be). The desired end product of electrolysis is often in a different physical state from the electrolyte and may be removed by one of several different physical processes such as, for example, by collecting a gaseous end product from above an electrode, by electrodeposition of the dissolved end product out of the electrolyte, or by removing solid end product buildup at one of the electrodes (e.g., scraping).

Whereas the decomposition potential of an electrolyte is the voltage needed for electrolysis to occur, the quantity of the end product derived from electrolysis is proportional to the electric current applied and, under Faraday's laws of electrolysis, when two or more electrolytic cells are connected in series to the same power source, the end product produced in the cells are proportional to their equivalent weight.

Solid-State Electrolysis

For “solid-state electrolysis,” a solid metallic compound or a mixture of metallic compounds (“active material”) may be reduced into a pure metal end product via electrolysis by placing the active material in direct contact with the cathode of the electrolytic cell. However, because various active materials are not naturally adhesive, placing active material onto a cathode surface (e.g., “pasting”) can be problematic.

Typically active material is pasted directly onto the cathode by removing the cathode from the electrolyte in the electrolytic cell and applying a mixture of active material and electrolyte onto the cathode surface. After this mixture is allowed to dry on the cathode, the cathode is then again suspended in the electrolyte of the electrolytic cell. However, at an industrial scale of operations, pasting of active material onto cathode surface is time-consuming and expensive due in part to the size of electrodes required for such pasting. Moreover, during electrolysis the dry-pasted active material on the cathode may absorb moisture from the electrolyte in the electrolytic cell, causing the pasted material to slough off or slide away from the cathode, and which also results in water-type electrolysis of this absorbed moisture, that together effectively substitutes for and/or precludes the desired electrolytic reaction of the active material. Additionally, it may be natural for what little end product that results to buildup at and adhere to the cathode itself, and removing this end product from the cathode may be time-consuming, inefficient, and expensive.

It is because of these inherent shortcomings that solid-state electrolysis has not been utilized for processing active materials commercially on an industrial scale, such industries opting instead for more traditional approaches for purifying active material into the desired end products such as, for example, smelting. However, as well-known and widely understood by skilled artisans, smelting has its own shortcomings and thus there remains a need for an alternative purifying process and machinery for performing same on an industrial scale.

Lead Acid Battery Recycling

Lead acid batteries (LABs) are widely used today and, unlike other battery types, are almost entirely recyclable, making lead acid batteries the single most recycled item today. Recycling lead is economically important because LAB production continues to increase globally year over year, yet production of new lead is becoming increasingly difficult due to depletion of lead-rich ore deposits. However, almost all current lead recycling from LABs at industrial scale is based on smelting, a pyro-metallurgical process in which lead, lead oxides (e.g., PbO and PbO2), and other lead compounds are heated to approximately 1600 degrees F. to 2200 degrees F. (900 degrees C. to 1200 degrees C.) and then mixed with various reducing agents to remove oxygen, sulfates, and other non-lead materials. Unfortunately lead smelting is highly polluting due to its generation of significant airborne waste (e.g., lead dust, arsenic, carbon dioxide, and sulfur dioxide), solid waste (e.g., slag that contains hazardous compounds of lead and other heavy metals), and liquid waste (e.g., sulfuric acid, arsenic, and other heavy metals and their oxides). Indeed, the pollution generated from smelting is so high that it has forced the closure of many smelters in the U.S. and other western nations to protect the environment. And although migration and expansion of smelting in less regulated countries has resulted in large scale pollution and high levels of human lead contamination in those countries, similar curtailing measures are expected in those countries as time progresses and new technologies become available.

Although numerous approaches for lead recycling from LABs are known in the art, they all suffer from one or more disadvantages that render them impractical. As such, there remains a need for improved devices and methods for scalable smelterless recycling of LABs that can achieve maximum lead recovery with minimal environmental impact and undue cost. And although some efforts have been made to move away from smelting operations and to use more environmentally friendly solutions, to date all have come up short for various reasons ranging from different pollution problems to low-yields and low-profitability to lab-type solutions that cannot be scaled up effectively or efficiently.

Electrolytic Processes

As briefly described earlier herein, elemental metals like gold, silver, copper, zinc, and lead may be recovered from materials containing these metals by various electrolytic processes (e.g., electrolysis). For example, with regard to recycling lead acid batteries (LABs), the lead paste obtained therefrom—typically comprising portions of pure lead as well as lead monoxide, lead dioxide, and lead sulfate—may be dissolved with or mixed in an electrolyte and the resulting solution or mixture then subjected to electrolytic recovery of pure elemental lead (Pb) at the cathode of an electrolytic device.

However, while conceptually simple and easily implemented on a small scale, the economic recovery of lead from battery paste via electrolytic processes on an industrial scale with sufficient yields and purity and undertaken in an environmentally-friendly manner— as an alternative to existing approaches which require high-temperature smelting—has heretofore been impractical and entirely unachievable. Electrode materials for lead recovery are relatively expensive and operating conditions at the electrodes tend to promote formation of undesirable side products. In existing electrolytic approaches, insoluble lead dioxide frequently forms at the anode, limiting current flow and diminishing operational effectiveness. Likewise, lead produced at the cathode using an acidic electrolyte will deposit as a film on the cathode surface, and this lead can be difficult to remove from the cathode. This deposited lead also re-dissolves into the electrolyte if/when the electric current—that is, the electrical supply performing the electrolysis—is discontinued. Other shortcomings also exist.

Accordingly, there is a need in the art and industry for scalable, cost-effective, and environmentally-friendly solutions that would enable the extraction and/or recovery of pure elemental metals from impure sources such as, for example, recovering near-pure lead (Pb) during LAB recycling.

As used herein (both heretofore and hereafter), the term “near-pure” shall mean a purity comparable to within 90% of the average purity obtainable by traditional smelting processes. Likewise, the term “pure” shall mean a purity that is equal to or exceeds the typical purity level obtainable by traditional smelting processes, and the term “perfect purity” shall mean a purity that is 99.000% comprised of the elemental metal without regard to natural surface oxidation or hydroxidation. Accordingly, for all implementations disclosed herein for obtaining “near-pure” metal, such disclosures should be deemed to also disclose alternative implementations for obtaining “pure” and “perfectly pure” metals as well. Also as used herein, the term “recovery” and other equivalent terms (e.g., purification, derivation, etc.) shall refer to the obtaining of a purer metal (e.g., elemental lead) from a less pure form of said metal (e.g., lead oxides) via electrolysis or other electrolytic processes.

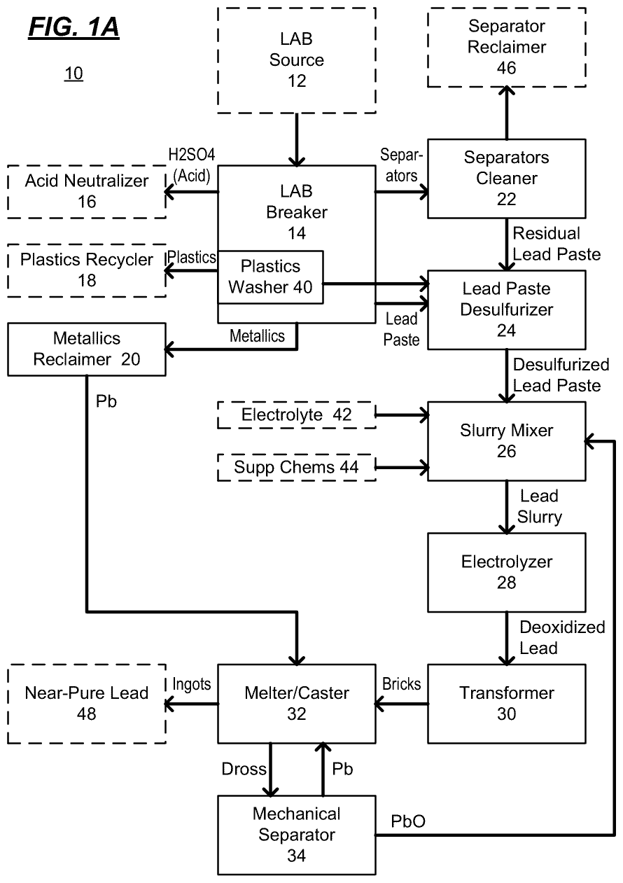

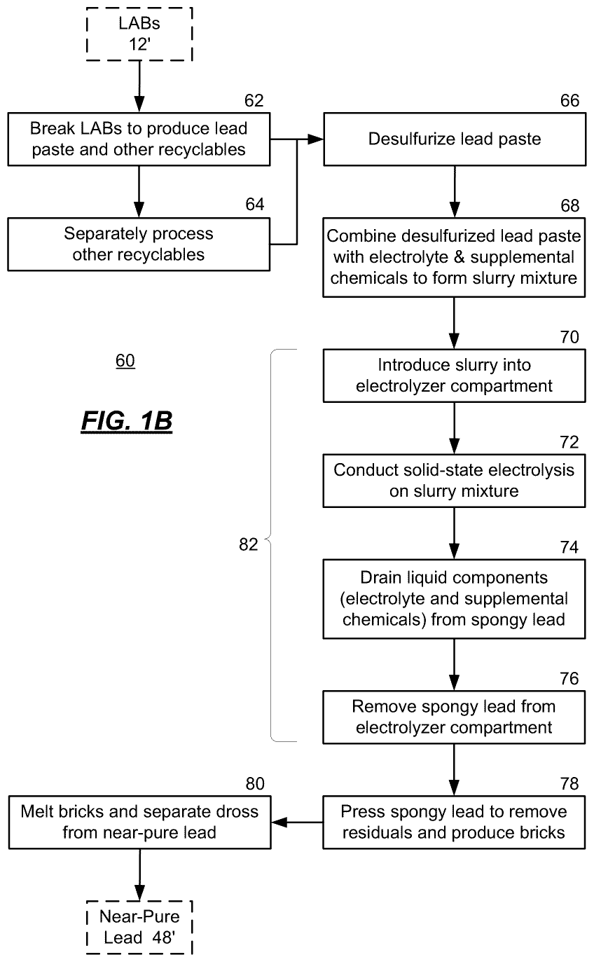

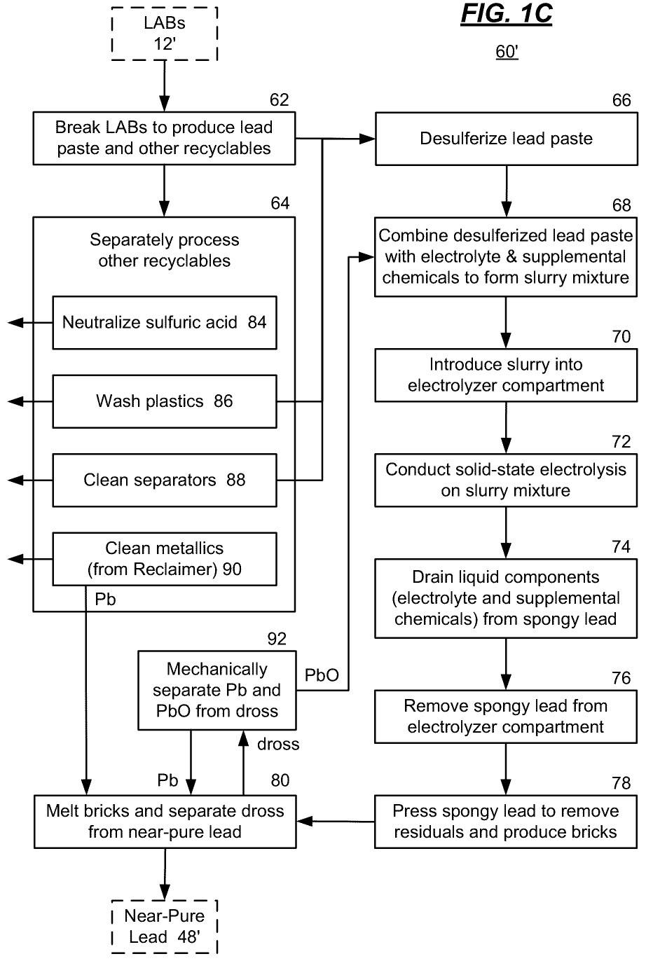

FIG. 1A is a modified block diagram 10 illustrating the major components of an exemplary end-to-end electro-chemical system for reclaiming near-pure lead from LABs— and indicating directional flow of materials between various subsystems thereof— representative of various implementations disclosed herein.

In FIG. 1A, LABs designated for recycling may be provided by an LAB source 12 (shown using dotted lines to indicate an input or output with regard to the system) to the LAB breaker 14 where the LABs may be physically reduced and divided into five main components: battery acid (when present), plastics, grid metallics, separators, and lead paste. The battery acid, which is typically sulfuric acid (H2SO4), may then be outputted to an acid neutralizer 16 for further processing, although this operation may not be necessary (and thus optional) when the LABs provided by the LAB source 12 have already had the battery acid removed or the acid is not otherwise present. The LAB breaker may also comprise a plastics washer 40 for removing lead residue (typically lead monoxide) adhering to the surface of the plastics before outputting the lead-free (or near-lead-free) plastics to a plastics recycler 18. Although not shown, and for certain implementations, a similar washing function could also be applied to the grid metallics to reclaim any lead residue adhering to said grid metallics. Additionally, the separators broken apart by the LAB breaker 14 may be conveyed to the separator cleaner 22 to recover residual lead therefrom which, along with the lead paste derived from LAB breaking by the LAB breaker 14 (either directly and/or from the plastics washer 40), are conveyed to the lead paste desulfurizer 24 with the remaining non-lead separator components output to the separator reclaimer 46.

Because washing the grid metallics may not (and typically would not) fully recover the oxidized lead from the lead paste adhering to the grid metallics broken apart by the LAB breaker 14, the grid metallics may be separated from the other broken LAB components and sent to a metallics reclaimer 20 to reclaim the lead components thereof—supporting recovery of pure lead (Pb) from the lead paste adhering to the grid thereof—and ultimately conveying the reclaimed pure lead to a melter 32 (described below) while properly outputting (e.g., disposing of or further recycling) the lead alloy of the grid for reuse in the making of new grids for new LABs, for example. Metallics reclaimer 20 and the recycling of grid metallics is disclosed is greater detail later herein.

The lead received by the lead paste desulfurizer 24 directly from the LAB breaking in the LAB breaker 14, from the plastics washer 40 thereof, and/or from the separator cleaner 22 typically comprises elemental lead (Pb), lead monoxide (PbO), and lead dioxide (PbO2), as well as lead sulfate (PbSO4). The lead paste desulfurizer 24 treats the lead paste to remove the sulfur from the lead sulfate (PbSO4), sulfur being a highly-damaging environmental pollutant. This desulfurization may be accomplished by the introduction of sodium hydroxide (NaOH) into the lead paste to chemically transform the lead sulfate (PbSO4) into lead hydroxide (Pb(OH)2) and the sodium hydroxide (NaOH) into sodium sulfate (Na2SO4), the sodium sulfate (Na2SO4) then being removed from the paste by the lead paste desulfurizer 24 utilizing any of various means known and appreciated by skilled artisans. In addition, barium sulfate (BaSO4) may also be added to the lead paste prior to or during the desulfurization process as an additive where the barium sulfate, which does not react with the sodium hydroxide (NaOH) during desulfurization, and is intentionally retained in the resultant (and otherwise “desulfurized”) lead paste in anticipation of being later removed by subsequent subsystems. As such, the desulfurization accomplished by the lead paste desulfurizer 24 intentionally removes only the sulfur from the lead sulfate (PbSO4). Regardless, the desulfurized lead paste—now comprising metallic lead only in the forms of elemental lead (Pb), lead monoxide (PbO), lead dioxide (PbO2), and lead hydroxide (Pb(OH)2)—may then be passed to the slurry mixer 26 where the desulfurized lead paste is combined with an electrolyte 42 and supplemental chemicals 44 (discussed in more detail later herein) to form a lead slurry solution or mixture.

Notably, for certain alternative implementations of the system 10, the plastics, grid metallics, separators, and lead paste may be provided to the system 10 directly and/or separately, already in broken form, by one or more input sources (not shown) in lieu of the LAB source 12, in which case such inputs may bypass the LAB breaker 14 and proceed to the appropriate other subsystem(s) accordingly. Likewise, for certain other alternative implementations, lead paste may instead be provided directly to the system, that is, either to the lead paste desulfurizer 24 if not yet desulfurized, or to the slurry mixer 26 if already desulfurized (with specific regard to the lead sulfate (PbSO4) but not to the barium sulfate (BaSO4) as explained above).

At the slurry mixer 26, and for several such implementations herein disclosed, sodium hydroxide (NaOH) may also be used as the electrolyte for subsequent electrolytic processing (e.g., electrolysis) of the lead paste, in which case the resultant lead slurry would be a mixture of the desulfurized lead paste and the electrolyte (and not a solution thereof in the chemical sense). The lead slurry is then transferred from the slurry mixer 26 to the electrolyzer 28 for electrolytic processing (described in more detail later herein). The electrolyzer 28 operates to produce substantially deoxidized elemental lead (Pb) from the lead monoxide (PbO), lead dioxide (PbO2), and lead hydroxide (Pb(OH)2) found in the lead slurry.

For certain other alternative implementations of the system 10, instead of desulfurizing the impure metal material prior to combining the impure metal material with the electrolyte to form the slurry, sulfur-containing impure metal material may be combined with the electrolyte to form a sulfur-containing slurry, and the electrolyzer itself may be utilized to desulfurize the impure metal material prior to or during the aforementioned electrolysis. For example, this additional functionality for the electrolyzer may be achieved through the consumption of stoichiometric caustic included in the electrolyte and causing in situ generation of sodium sulfate which is separable from the resultant deoxided lead in subsequent processing.

Regardless, the resultant deoxidized lead then may be transferred to the transformer 30 for transformation into solid bricks having minimal amounts of the electrolyte and/or the supplemental chemicals. For lead slurry mixtures (but not solutions), much of the electrolyte and/or supplemental chemicals may be drawn off by the electrolyzer 28 before being transferred to the transformer 30, and/or the transformer may comprise physical pressing of the deoxidized lead into solid bricks, said pressing also being effective in removing much of the residual electrolyte and/or supplemental chemicals. For lead slurry solutions, on the other hand, the transformer 30 might instead precipitate the deoxidized lead and thereby separate it from the electrolyte and supplemental chemicals before then pressing it into bricks.

The lead bricks—which may still have some minimal amount of electrolyte, supplemental chemicals and other impurities including but not limited to barium sulfate (BaSO4), oxidized lead (lead monoxide, lead dioxide, and/or lead hydroxide), as well as any new natural oxidation occurring on the surface of the bricks—are then sent to the melter/caster 32 for melting down, drawing off dross, and casting as output ingots of near-pure lead 48. This melting and casting may also include as input any pure lead reclaimed by the grid metallics reclaimer 20 identified earlier herein and discussed in greater detail later herein. The dross, on the other hand, may be passed to a mechanical separator 34 to separate elemental lead (Pb) for subsequent return to the melter/caster 32, and lead monoxide (PbO)—along with other impurities together forming lead dross—for return to the slurry mixer 26 and inclusion in the next mix of lead slurry for subsequent processing (disclosed in greater detail later herein). Separately, for select implementations the barium sulfate (BaSO4), electrolyte, and supplemental chemicals (and remnants thereof) may be recovered at various points in the system and/or reused (not shown).

Typically dross is physically skimmed to the rim of the melting container (sometimes referred to as a “kettle” or “pot”) and manually or mechanically shoveled (or “spooned”) into a separate container. Historically dross was manually removed from large kettles by two people, one using a pusher to push dross across the surface of the molten metal bath to another equipped with a perforated spoon which was manipulated to scoop up the dross and, after allowing molten lead to drain back into the kettle through the perforations in said spoon, to discharge the dross into a separate dross container. More processes fundamentally replicate this historical methodology using manual, mechanical, or a combination of manual/mechanical means that are well-known and readily-appreciated to skilled artisans, as are other mechanical dross-removal methods such as “vacuum drossing” and other non-traditional approaches.

FIG. 1B is a process flow diagram 60 illustrating an exemplary approach for LAB recycling using the system of FIG. 1A representative of the various implementations disclosed herein. In FIG. 1B, at 62 LABs received for recycling may be broken to produce lead paste and other recyclable, the latter of which may be separately processed at 64 as generally described earlier herein with regard to FIG. 1A. Any additional lead recovered from this separate processing may be returned and combined with the lead paste directly resulting from the breaking at 62.

At 66 the lead paste derived at 62 (and 64 if any) may then be desulfurized—such as by treating with sodium hydroxide (NaOH), potassium hydroxide (KOH), ammonium hydroxide (NH4OH) or aqueous solution of ammonia, or other suitable chemicals—such that the resulting desulfurized lead paste substantially comprises sulfur-free lead components, e.g., Pb, PbO, PbO2, and Pb(OH)2) but no lead sulfate (PbSO4). At 68 the desulfurized lead paste may be combined with an electrolyte and supplemental chemicals to form a slurry mixture (or, in alternative implementations, a slurry solution). At 70, this slurry is then introduced into an electrolyzer cell and, at 72, solid-state electrolysis (or, in alternative implementations, typical solution-based electrolysis) may be performed.

Once electrolysis is complete, at 74 the liquid components (which may include supplemental chemicals or remnants thereof) may then be drained first and, at 76, the remaining solid components resulting from the electrolysis—which may be in the form of “spongy lead” solids permeated with residual liquid components—may also be removed, or in alternative implementations the liquid components and solid components may be removed from the electrolyzer simultaneously. At 78 the “spongy lead” solid components—which now substantially comprise pure lead (Pb)—may be pressed to remove nearly all remaining liquid components (“residuals”) and form substantially pure lead bricks. At 80 the lead bricks may then be melted to eliminate nearly all remaining trace amounts of non-lead components and other minor impurities—said melting occurring (at temperatures far below those required for smelting—to further purify the lead bricks and form near-pure lead ingots for output.

Notably, elements 70-76 of FIG. 1B—denoted as the electrolytic process group 82 in the figure—are performed utilizing the various implementations of an electrolytic cell described in greater detail below, although nothing herein limits utilization of such implementations to lead recycling or to just this portion of a lead recycling process; on the contrary, other additional utilizations of such implementations are also anticipated by such implementations. For example, various implementations disclosed herein may be used to further process the dross removed during the melting 80 including but not limited to the processing described with regard to FIG. 1A above.

FIG. 1C is a modified process flow diagram 60′ of the process 60 shown in FIG. 1B to further illustrate in more detail the separate processing of the other recyclables 64 and dross processing 92 that are representative of the various implementations disclosed herein. In FIG. 1C, at 84 the battery acid—which is typically sulfuric acid (H2SO4)—is neutralized and outputted from the system. At 86 the plastics are washed and outputted from the system with any lead residue (typically lead monoxide) recovered from the surface of the plastics being combined with the lead paste to be desulfurized. Likewise, at 88 the separators are also washed and outputted from the system with any lead residue (typically lead monoxide) recovered from the surface of the plastics being combined with the lead paste to be desulfurized. And at 90 the grid metallics may be “cleaned” with components other than recoverable lead—such as lead alloy from the grid—being outputted (discarded or recycled) and the recoverable lead components thereof—ultimately pure lead (Pb) derived from the lead paste adhering to the grid thereof—conveyed directly to the melter for melting at 80 or, for lead paste and other forms of oxidized lead, being routed for further processing at 66, for example.

As disclosed earlier herein, often the grid recovered from the grid metallics of an LAB is constructed from a lead alloy comprising lead (Pb) and antimony (Sb)—that is, lead antimony (or antimonial lead). While the lead and the antimony from the alloy could be separated using known processes for doing so—and thereby increasing the amount of elemental lead recovered and applicable for certain select implementations herein disclosed—the need for recycled antimonial lead (i.e., the lead alloy) for use in new grids for new batteries warrants no separation of the lead from the antimony in such alloys but, instead, for reuse of the lead antimony as a separate recycle product as disclosed for various other implementations described herein. For such implementations where the elemental lead in the alloy need not be separated from the antimony (leaving the alloy intact), this alloy of lead antimony may be melted by the reclaimer 90, directed from the reclaimer 90 to the same melter used in the melting at 80, or otherwise melted to form clean antimonial lead ingots. Specific implementations directed to recovery of lead alloy and specific processing of grid metallics is disclosed in greater detail later herein.

Also shown in FIG. 1C is an approach for the dross that results from the melting at 80 being mechanically separated, at 92, with the lead monoxide (PbO) resulting from the mechanical separation being added, directly or indirectly, to a subsequent batch of desulfurized lead paste at 68 for re-processing, while elemental lead (Pb) resulting from the mechanical separation is added back into a subsequent batch of spongy lead being melted at 80 (disclosed in greater detail later herein).

Electrolyzer Cell with Horizontal Cathode

Disclosed herein is an electrolyzer cell comprising a horizontal cathode over which a horizontal anode is suspended. The horizontal cathode may form the base of an electrolyzer compartment into which a mixture of active material and electrolyte—in the form of a slurry, for example—may be introduced, held, and processed. The horizontal anode may be suspended above the cathode in the upper portion of the electrolyzer compartment in such a manner that the anode would physically engage the upper surface of the mixture of active material and electrolyte being held by the electrolyzer compartment while the cathode would naturally engage the bottom surface of the mixture of active material being held in the electrolyzer compartment. The anode may also comprise small openings in the form of vents, trenches, holes, or the like (which may be referred to herein simply as “breathing holes”) across the surface of the anode in order to allow gaseous oxygen (O2) and/or other gaseous substances resulting from the electrolysis to harmlessly escape (instead of being trapped under said anode and creating current resistance).

Accordingly, various implementations disclosed herein may be directed to and/or make use of an electrolyzer comprising a horizontal cathode located below a suspended anode for purposes of performing electrolysis on metal-bearing mixtures or solutions. For several such implementations, the horizontal cathode may comprise the bottom surface of a compartment for containing a mixture or solution of metal components, electrolyte, and/or supplemental chemicals; a horizontal anode for engaging the upper surface of the mixture or solution in the compartment; a gate corresponding to one sidewall of the compartment for facilitating removal of the end-products from the mixture or solution; and/or a removal mechanism for facilitating removal of the end-products of the mixture or solution from the compartment (and the surface of the horizontal cathode) through the gate. Certain implementations disclosed herein are specifically directed to use in recycling of lead acid batteries (LABs) without smelting, although nothing herein is intended to limit the various implementations solely to LAB recycling or lead recovery and, instead, the various implementations disclosed herein may be applied to a variety of different electrolysis operations.

For these various implementations—and in combination with use of additional supplemental chemicals added to the slurry mixture of active material and electrolyte (discussed further below)—an electrical DC current may then be passed from the cathode to the anode through the mixture of active material and electrolyte to produce the desired end product and cause that desired end product to settle on the surface of the cathode. (For certain such implementations, the end product may be pure lead in a spongy form that retains some of the electrolyte and/or supplemental chemicals.) More specifically, the electrical DC current would effectively cause the reduction of metal ions in the active material to disassociate from their counter ion—such as oxide and hydrogen ions which in turn may form water (H2O) and gaseous oxygen (O2)—and the metal, now in its pure form, would then be drawn to and settle upon the horizontal cathode surface due in part to gravity (the metal being heavier than other components in the slurry) and aided in part by the natural ionic convection that occurs in the mixture during electrolysis.

Once the electrolysis is complete, and for several such implementations herein disclosed, the electrolyzer compartment may further comprise an openable side for removing the electrolyte (including the supplemental chemicals and the additional H2O produced during the electrolysis) as well as the end-product metal. Initially this openable side may be only partially opened in order to first permit the purely liquid components—i.e., much of the remaining electrolyte, supplemental chemicals, and the additional water (H2O) produced during the electrolysis—to exit the electrolyzer compartment and, for certain implementations, be channeled away via a small channeling gutter at the base of the openable side. In some implementations, this channeling gutter may then be moved to a storage position away from the openable side (e.g., to below the electrolyzer compartment) after the liquid components have been drained through the openable side of the electrolyzer compartment.

After the liquid components have been drained away—or, in alternative implementations, without first draining the liquid components separately—the openable side may be fully opened to permit the more solid components—namely the end-product metal plus any residual liquid components adhering thereto—to be physically removed from the electrolyzer compartment. For select implementations, the removal may be performed by a vertically-oriented scraping mechanism extending across the width of the electrolyzer compartment and originating on the side opposite the openable side, said scraping component physically contacting and gently scraping the entire cathode surface and adjoining sides of the electrolyzer compartment but operating just below (and without physically contacting) the anode surface. In this manner, the scraping mechanism may operate to push the more solid components out of the electrolyzer compartment and into a collecting receptacle or onto a conveying mechanism (e.g., a conveyor belt) for further processing.

In this manner, the various implementations disclosed herein may overcome the shortcomings in existing approaches to solid-state electrolysis described above as follows: (1) there would be no need to dry-paste the active material to the cathode, saving time and effort; (2) the build-up of absorbed water by the dry-pasted active material during electrolysis—and the interference with the production of the desired end product that results—could be avoided altogether; and/or (3) the buildup of the end product at the cathode would be easier to remove as the flat surface of the cathode facilitates the scraping action (described above) and the supplemental chemicals may help prevent solidification of the end product or adhesion of the end product to the cathode.

Furthermore, for various implementations disclosed herein, multiple electrolyzer cells of the type described herein can be stacked vertically, with appropriate spacing between each electrolyzer cell, which might share a single vertical drop space for the end product pushed out of the multiple electrolyzer cells in a single collecting receptacle or onto a single conveying mechanism. Additionally, several vertical stacks comprising multiple electrolyzer cells can be arranged in a row and further share a single elongated collecting receptacle or a single elongated conveying mechanism. Moreover, multiple rows of vertical stacks can also be arranged with the produced end product being consolidated for continued processing.

Notably, separate from the disclosures made herein, Applicant has discovered that achieving the electrolytic effects described herein is dependent upon the utilization of certain specific chemicals mixed into the slurry along with the electrolyte and active materials. Although the present application is not directed to the composition of any of the these discovered chemicals, the various implementations disclosed herein are in no way limited to the use of any specific chemical additives regardless of whether secret or proprietary (or widely-used and well-known for that matter).

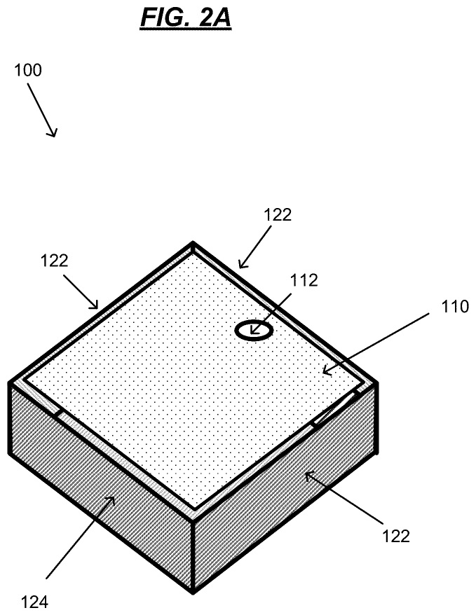

FIG. 2A is an illustration providing a perspective view of an electrolyzer cell 100 representative of various implementations disclosed herein. FIG. 2B is an illustration providing a blown-out perspective view of the anode 110 and the interior of the electrolyzer cell 100 of FIG. 2A representative of various implementations disclosed herein. For convenience, FIG. 2A and FIG. 2B may be referred to herein collectively as FIG. 2.

As illustrated in FIG. 2, an electrolyzer cell 100 may comprise an anode 110 suspended above a horizontal cathode 120 at a distance suitable for performing electrolysis. The electrolyzer cell 100 may also comprise vertical containing surfaces 122 and at least one gate 124 that, together with the horizontal cathode 120, form and provide an electrolyzer compartment 126 into which a mixture of active material and electrolyte—in the form of a slurry, for example—may be introduced, held, and processed. The vertical containing surfaces 122 and the gate 124—or at least the internal surfaces thereof relative to contents of the electrolyzer compartment 126—may be electrically non-conductive.

As shown, the anode 110 may be configured as a horizontal anode, although other forms of anode may also be utilized such as, for example, a series of anode rods, strips, grids, or other structures that could physically engage the upper surface of an electrolytic slurry emplaced onto the cathode. Regardless, the anode 110 may be suspended above the cathode 120 in the upper portion of the electrolyzer compartment 126 in such a manner that the anode would physically engage the upper surface of the mixture of active material and electrolyte being held by the electrolyzer compartment while the cathode would naturally engage the bottom surface of the active material mixture being held in the electrolyzer compartment. For those implementations featuring a horizontal anode, the anode 110 may also comprise small openings or vents 114 (i.e., “breathing holes”) across its surface to allow gaseous oxygen (02) resulting from electrolysis to harmlessly escape (instead of building up under said anode). The anode 110 may also comprise an opening 112 through which the electrolytic slurry may be emplaced into the electrolyzer compartment and onto the horizontal cathode 120 in sufficient quantity for an upper surface of said electrolytic slurry to simultaneously physically engage the suspended anode 110 and thereby complete the circuit for a current running between the cathode 120 and anode 110 for purposes of electrolysis.

The electrolyzer cell 100 may further comprise a removing mechanism 160. For various implementations, this removing mechanism 160 may comprise a vertically-oriented surface extending across the width of the electrolyzer compartment 126 and originating on the side opposite the gate 124, said surface being capable of physically contacting and gently scraping the entire cathode 120 surface and adjoining sides of the electrolyzer compartment 126 and operating below the anode 110 surface. The removing mechanism—or at least the portions thereof exposed to the contents of the electrolyzer compartment 126—may be electrically non-conductive.

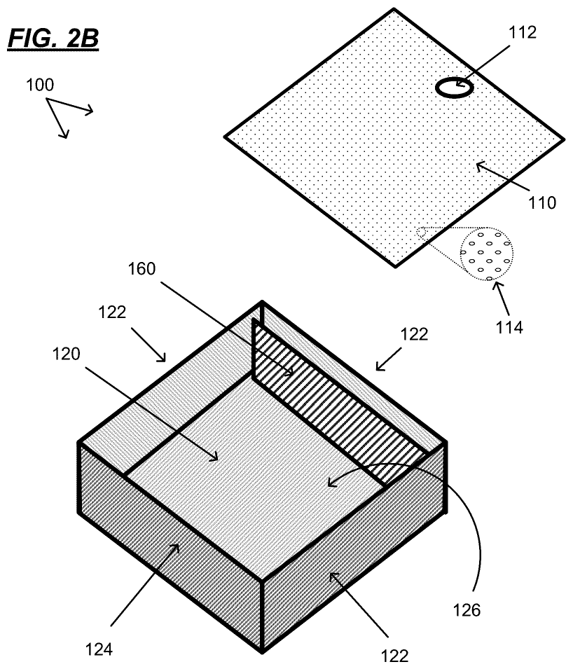

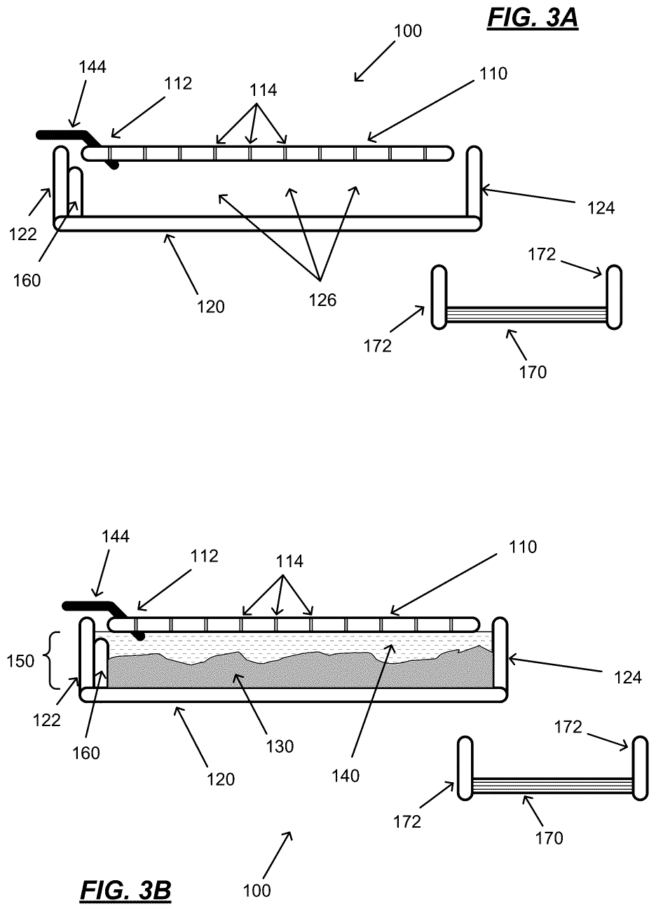

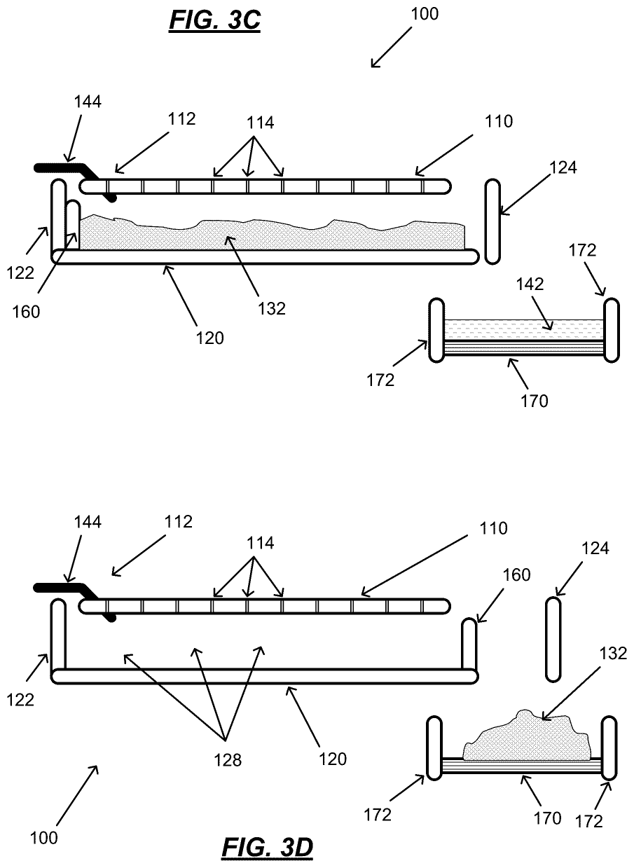

FIG. 3A is an illustration providing a cut-away side view of the electrolyzer cell 100 of FIG. 2A and FIG. 2B, representative of the various implementations disclosed herein, in an initial ready-to-use configuration for conducting electrolysis. As illustrated in FIG. 3A, the electrolyzer compartment 126 is empty but ready to be filled, with the removal mechanism 160 in a set position and with the gate 124 closed. In this configuration, an electrolytic slurry may then be emplaced into the electrolyzer compartment 126 and onto the horizontal cathode 120 via a slurry line 144 extending through the opening 112 in the anode 110. Also shown in FIG. 3A is a conveyor belt 170 comprising containing sides 172 and disposed beneath the gate 124 as a conveying mechanism for use during removal of the contents of the electrolyzer compartment 126 after electrolysis is complete.

FIG. 3B is an illustration providing a cut-away side view of the electrolyzer cell 100 of FIG. 2A and FIG. 2B (as well as FIG. 3A), representative of the various implementations disclosed herein, after being filled with electrolytic materials 150 for electrolysis. As illustrated in FIG. 3B, the electrolytic materials 150 comprise a mixture of active materials 130 and electrolyte 140 as well as supplemental chemicals interspersed therein. The bottom surface of the electrolytic materials 150 physically engages (i.e., is in physical contact with) the horizontal cathode 120 while the upper surface of the electrolytic materials (specifically, the electrolyte component thereof) physically engages the anode 110. (For various implementations, sufficient electrolyte may be included in the electrolytic materials to form the upper surface of the electrolytic materials in order to prevent solid material contact from developing between the cathode and anode which might create an electrical short and prevent the cathode plate from reducing lead ions from the compounds.) An electric current can then be applied to the electrolytic materials 150 via the anode 110 and cathode 120, with the electrical circuit being completed by the mobile ions in electrolyte 140, and with electrolysis taking place in said electrolytic materials 150 accordingly.

FIG. 3C is an illustration providing a cut-away side view of the electrolyzer cell 100 of FIG. 2A and FIG. 2B (as well as FIG. 3A and FIG. 3B), representative of the various implementations disclosed herein, after electrolysis has been performed and liquid components 142 have been drained from the electrolyzing compartment 126 by opening the gate 124 into a first position that provides sufficient space through which said liquid components can pass from the electrolyzer compartment 126 onto the conveyor belt 170 for recovery of said liquid components. Meanwhile the desired end product 132 of the electrolysis remains on the horizontal cathode 120 awaiting its own removal from the electrolyzer compartment 126.

FIG. 3D is an illustration providing a cut-away side view of the electrolyzer cell 100 of FIG. 2A and FIG. 2B (as well as FIG. 3A, FIG. 3B, and FIG. 3C), representative of the various implementations disclosed herein, after the end product 132 resulting from the electrolysis has been removed from the horizontal cathode 120 surface and from the electrolyzing compartment. As shown in FIG. 3D, the gate 124 has moved to a second fully-open position and the removal mechanism 160 has traversed the interior of the electrolyzer cell 100 and removed the end product 132 from the electrolyzer cell 100 and onto the conveyor belt 170. With the removal mechanism 160 in this deployed position and the gate 124 fully open as shown, the empty interior of the electrolyzer cell 128 is no longer an electrolyzing compartment 126 but will again become an electrolyzing compartment 126 after the removal mechanism 160 is returned to its original position and the gate 124 is closed (as shown in FIG. 3A for example). For convenience, FIG. 3A, FIG. 3B, FIG. 3C, and FIG. 3D may be collectively referred to herein as FIG. 3.

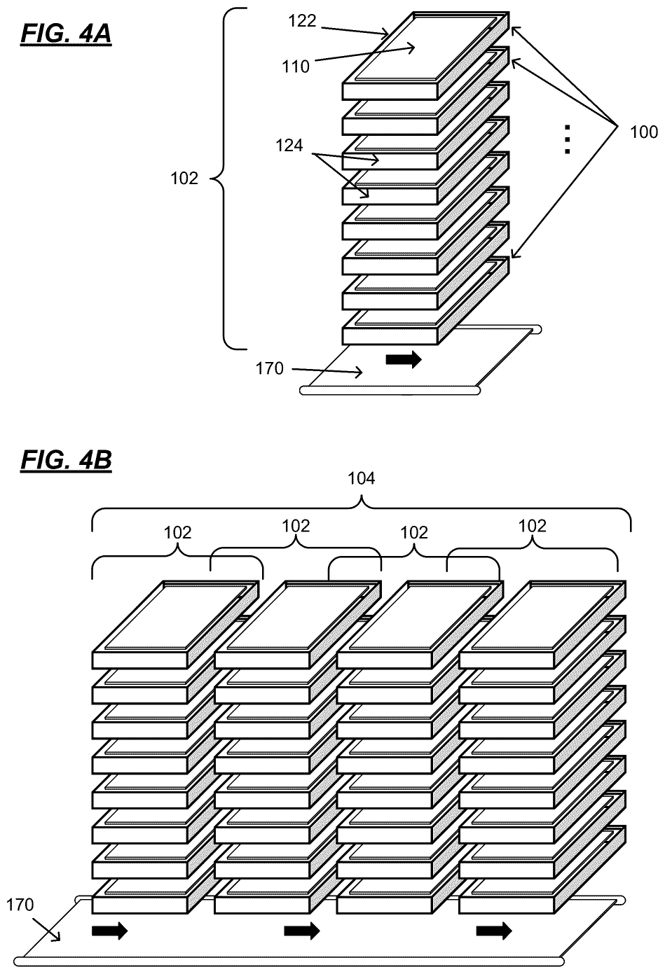

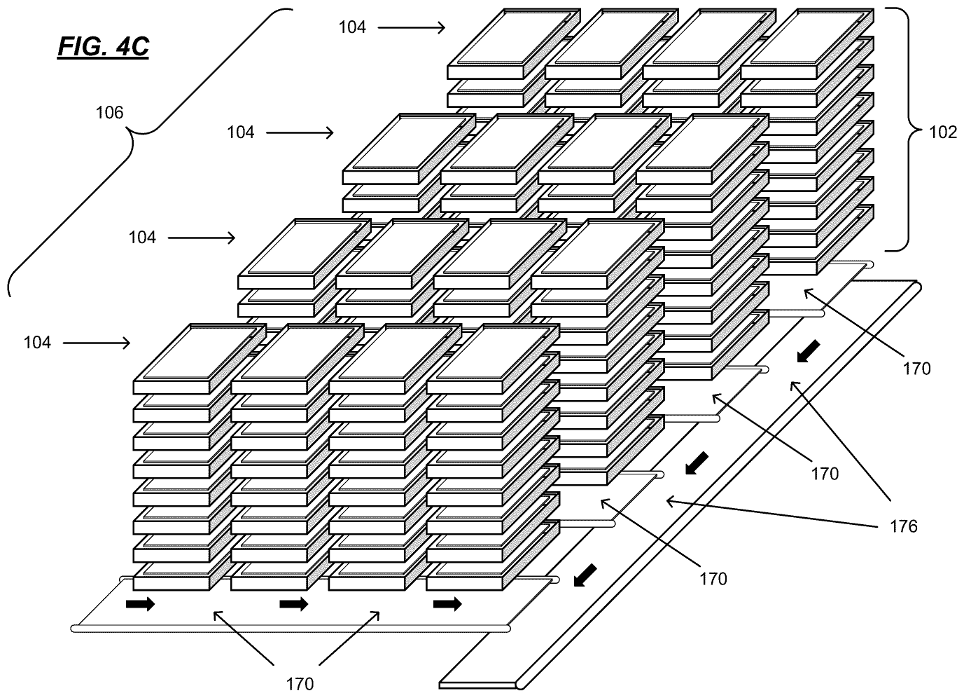

FIG. 4A is an illustration providing a perspective view of a vertical stack 102 of electrolyzer cells 100 representative of various implementations disclosed herein. As shown in FIG. 4A, multiple electrolyzer cells 100 may be vertically orientated over a single conveyor belt 170 (further distinguished in the drawing by the block motion arrow) in order to increase overall capacity, minimize floorspace (or footprint), and increase conveyor belt 170 utilization (and minimize conveyor belt 170 buildout).

FIG. 4B is an illustration providing a perspective view of a lateral line 104 comprising multiple vertical stacks 102 of electrolyzer cells 100 representative of various implementations disclosed herein. As shown in FIG. 4B, multiple stacks may be linearly oriented over a single conveyor belt 170 to further increase overall capacity while again increasing conveyor belt 170 utilization (and minimize conveyor belt 170 buildout) versus the need for individual conveyor belts for each stack 102. Furthermore, for certain implementations, multiple stacks 102 may be oriented on both sides of the conveyor belt 170 to form a duplex line (not shown).

FIG. 4C is an illustration providing a perspective view of a parallel array 106 of multiple lateral lines 104 each comprising multiple stacks 102 of electrolyzer cells 100 representative of various implementations disclosed herein. As shown in FIG. 4C, a plurality of lateral lines 104 and their corresponding conveyor belts may be arranged to form a three-dimensional array 106 of electrolyzer cells that feed into a consolidated cross-conveyor belt 176. Furthermore, for certain implementations, the conveyor belts 170 from multiple lines 104 may be oriented on both sides of the cross-conveyor belt 176 to form a duplex array (not shown). Moreover, the specific height, length, and width of such a parallel array 106 can be configured to optimally fit in almost any three-dimensional space although alternative or additional conveyor belt configurations may be needed.

With regard to all of the various implementations disclosed herein, alternative implementations are also anticipated wherein the horizontal cathode is instead a horizontal anode and the suspended anode is instead a suspended cathode. Moreover, each step of the processes performed by the various implementations herein disclosed may be performed and controlled by a processing unit or other computing environment to include (but in no way limited to) timing of each step of the operation, coordination between different electrolyzer cells, slurry lines, conveyor belts, etc., and variations in time and charge utilized throughout the electrolysis processes, as well as receiving and reacting to feedback from electrical resistance and other detectable occurrences from the electrolysis while in progress.

Electrolyte and Supplemental Chemicals

As disclosed earlier herein, sodium hydroxide (NaOH)—as well as potassium hydroxide (KOH) and the like—may be used as the electrolyte for subsequent electrolytic processing (e.g., electrolysis) of the lead paste, in which case the resultant lead slurry would be a mixture of the desulfurized lead paste plus the electrolyte (and not a solution thereof in the chemical sense). This approach is a departure from typical electrolytic processing of lead paste dissolved and suspended in an electrolyte solution, noting that typical electrolytic processing has no need of the supplemental chemicals whereas electrolytic processing of a mixture benefits from the supplemental chemicals.

Also, as known and appreciated by skilled artisans, lead monoxide (PbO) can be removed from dross by the utilization of sodium hydroxide (NaOH) which acts to dissolve the lead monoxide (PbO) and forms a solution that is effectively separate from the other solid impurities comprising the dross. Once the dissolved lead-containing solution is separated from the solid dross remnants—that is, after the solid remnants are filtered from the solution—the lead monoxide (PbO) solution can be further processed to recover pure lead (Pb) therefrom.

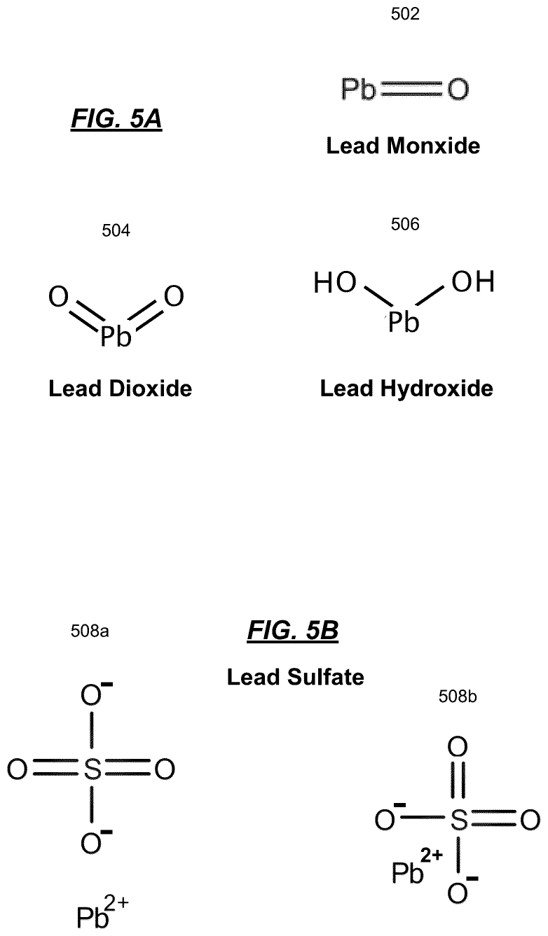

FIG. 5A is an annotated chemical illustration of the respective molecular structures for lead monoxide (PbO) 502, lead dioxide (PbO2) 504, and lead hydroxide (Pb(OH)2) 506 (collectively the “oxidized lead components” or “lead oxides”). FIG. 5B is an annotated chemical illustration of the respective molecular structures for lead sulfate (PbSO4) which, for clarity, is shown with bonding charges 508a and without 508b (that is, with the lead (Pb) atom collocated with the two oxygen atoms having a single bond with the sulfur atom). As previously mentioned, the lead paste derived from LABs during recycling typically comprising portions of pure lead as well as lead monoxide, lead dioxide, and lead sulfate.

Lead monoxide (PbO)—also commonly referred to as lead(II) oxide—has a +2 oxidation state. PbO is formed during discharge of the LAB as a proton-electron mechanism of PbO2 reduction (noting that the positive plate of an LAB is comprised of PbO2 whereas the negative plate of the LAB is comprised of pure lead Pb).

Lead dioxide (PbO2)—also commonly referred to as lead(IV) oxide—has a +4 oxidation state. The positive plate of an LAB is comprised of PbO2 whereas, in contrast, the negative plate of the LAB is comprised of pure lead Pb.

Lead hydroxide (Pb(OH)2)—also commonly referred to as lead(IV) oxide or less precisely as “lead hydrate” (this latter term also used to refer to Pb(H20)2)—has a +2 oxidation state. Pb(OH)2 results from interactions between the PbO2 plate in an LAB and the aqueous sulfuric acid (H2SO4) solution of the LAB (and also resulting in PbSO4). As described earlier herein, lead sulfate (PbSO4) is converted into lead hydroxide (Pb(OH)2) during desulfurization that occurs before electrolytic processing.

In order for an electrolytic process to successfully recover elemental lead (Pb) from the lead oxides present in the lead slurry prepared for solid-state electrolysis, one or more supplemental chemicals may be added to the lead slurry mixture (comprising the electrolyte and oxidized lead components) prior to electrolytic processing. During electrolysis these supplemental chemicals would effectively enable the oxygen (O) and/or hydroxide (OH) molecules in the lead oxides to disassociate from the lead (Pb) and combine to form gaseous O2 (which may then dissipate out of the mixture and into the surrounding air) and/or aqueous water (H2O) (which may then remain in the mixture and be pressed out or boiled away in subsequent processing of the resultant elemental lead (Pb)).

In particular, in order for an electrolytic process to successfully recover elemental lead (Pb) from lead monoxide (PbO) in a lead slurry during solid-state electrolysis, various implementations disclosed herein utilize one or more PbO-specific supplemental chemicals (hereinafter referred to as “MoXX”) that are added to the lead slurry mixture (comprising the electrolyte and PbO components) prior to electrolytic processing. When AXC is included as a supplemental chemical mixed with the lead paste and electrolyte for solid-state electrolytic processing, during the electrolysis the AXC effectively assists the oxygen (O) in lead monoxide (PbO) to disassociate from the lead (Pb) and to combine with other oxygen (O) to form gaseous O2 (which may then dissipate out of the mixture and into the surrounding air) or to combine with hydrogen (H) and other oxygen (O)—generally in the form of an hydroxide (OH) anion—to form aqueous water (H2O) in the mixture. The latter of these byproducts may then be pressed out or boiled away in subsequent processing of the resultant elemental lead (Pb).

As such, various implementations disclosed herein may be directed to the recovery of pure lead (Pb) specifically from lead monoxide (PbO) present in paste derived from LABs. Various such implementations are directed to methods for recovery of near-pure elemental lead (Pb) from material comprising lead monoxide (PbO) by: mixing the material with an electrolyte and at least one supplemental chemical to form a slurry, said slurry being a mixture of the material and the electrolyte wherein the electrolyte does not dissolve the lead monoxide in the material; performing solid-state electrolysis on the slurry in order to convert the lead monoxide into the elemental lead in a spongy form; pressing the spongy lead to substantially remove the electrolyte; melting the spongy lead to produce near-pure elemental lead and dross; and removing the dross from the near-pure elemental lead.

Recovery of Oxidized Lead from Non-Lead Components

As disclosed and/or described earlier herein, LABs designated for recycling are first physically reduced (or “broken”) and separated/divided into five main subcomponents: battery acid (when present), plastics, separators, grid metallics, and lead paste. The battery acid, which is typically sulfuric acid (H2SO4), may be outputted to an acid neutralizer, and the lead paste may be immediately directed to primary lead recovery operations. The other components, however—namely the plastics, separators, and grid metallics—must first be “washed” and cleaned of any incorporated or adhering oxidized lead (often in the form of residual battery paste) before they can be further processed and reclaimed. Unfortunately, as well-known and readily-appreciated by skilled artisans, the washing of these components— especially Absorbent Glass Mat (AGM) separators—is notoriously difficult, and as much as 0.5% of the oxidized lead remains unrecovered from such components and often reenters the environment as lead pollution.

To address these challenges, various implementations disclosed herein are directed to systems, methods, processes, and/or chemical compositions for the recovery of oxidized lead from non-lead components of recycled LABs, and specifically from the plastics, separators, and grid metallics components thereof. The several and various implementations disclosed herein feature new processes, innovative electrolyzer designs, and/or novel utilization of supplemental chemicals necessary for successful subsequent electrolytic processing of oxidized lead to transform it into near-pure elemental lead.

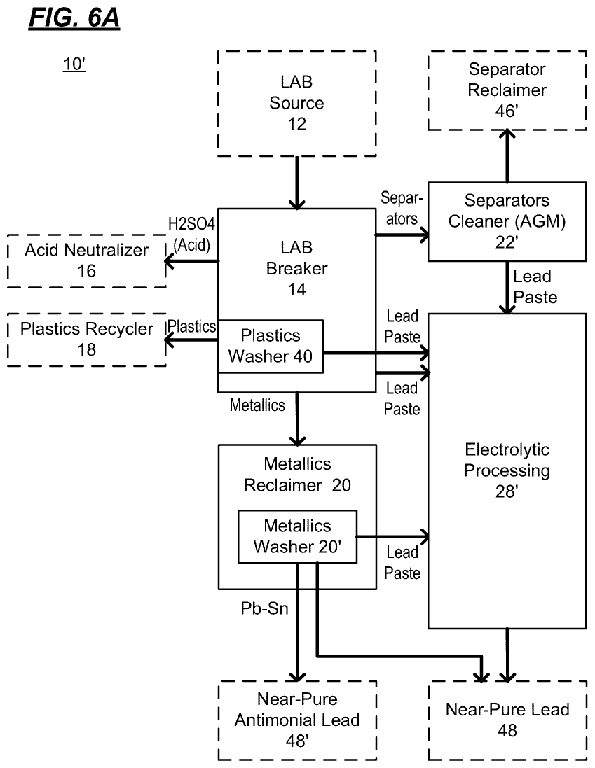

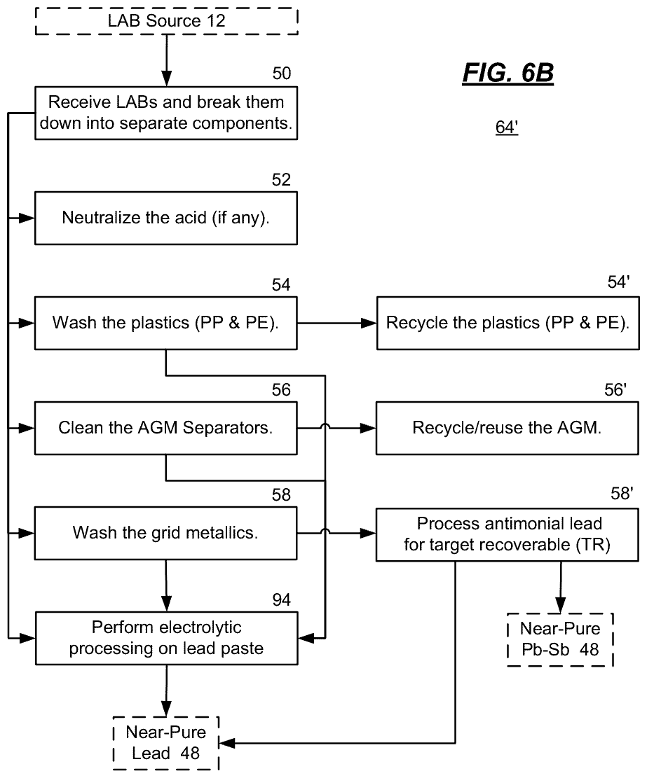

FIG. 6A is a partial modified block diagram 10′ illustrating the major components of an exemplary washing subsystem, based in part on the system 10 illustrated in FIG. 1A, for recovery of oxidized lead from a non-lead component (NLC) during lead-acid battery (LAB) 12 recycling representative of various implementations disclosed herein. In FIG. 6A, the washing subsystem 10′ comprises a LAB breaker operationally coupled to a plastics washer 40, a separator cleaner 22, and a metallics reclaimer 20 (comprising a metallics washer 20′), among other components, and all of these components are operationally coupled to electrolytic processing 28′ (representing most of the blocks of FIG. 1A not individually illustrated in the present FIG. 6A).

FIG. 6B is a partial modified process flow diagram illustrating an exemplary washing process, based in part on the approach illustrated in FIG. 1B and FIG. 1C, for recovery of oxidized lead from a non-lead component (NLC) during lead-acid battery (LAB) recycling representative of various implementations disclosed herein. In FIG. 6B, at 50 the LABs are received and broken into their separate components: battery acid (when present), which at 52 is neutralized; plastics, which at 54 are washed and at 54′ are recycled; AGM separators, which at 56 are cleaned (washed) and at 56′ are recycled or reused; lead paste, upon which at 94 electrolytic processing is performed—using any of the processes disclosed earlier herein—to produce near-pure lead (Pb) 48; and grid metallics, which at 58 are washed and at 58′ have the remaining antimonial lead (and lead paste still adhering thereto) processed to further recover the target metal and/or alloy (lead paste and/or clean lead antimony (Pb—Sb)) which is described in more detail in the next section.

Accordingly, various implementations disclosed herein are directed to methods and/or systems for removing oxidized lead from non-lead components. More specifically, various implementations disclosed herein are directed to methods for recovery of oxidized lead from a non-lead component (NLC) during lead-acid battery (LAB) recycling, the methods comprising: immersing and agitating the NLC in a solution, comprising at least one supplemental chemical, that causes the oxidized lead to separate from the NLC and form a resultant mixture comprising the solution and the oxidized lead; removing the NLC from the resultant mixture and washing the NLC with water to remove any adhering resultant mixture; and performing an electrolytic process on the mixture to deoxidize the oxidized lead and thereby produce elemental lead (Pb) therefrom. This approach may also be utilized for a preliminary wash of the grid metallics before further processed as described in more detail in the next section.

Recovery of Oxidized Lead and Lead Alloy from Grid Metallics

To maximize effective surface area and thereby increase the efficiency of current flow, one or more pairs of grid metallics (each a “plate”) is commonly used in an LAB for both the positive and negative electrodes within the battery. Typically these plates comprise a metallic grid (usually a lead alloy) upon which a lead-based paste—which may comprise lead oxides, sulfuric acid, and water—is emplaced and cured in a manner that causes adherence to the metallic grid and, upon initial charging (“formation”), becomes the electrochemically active material (“active mass”) for such plates/electrodes. In a fully charged state the active material for positive plates may mostly comprise lead dioxide while the active material for negative plates may mostly comprise elemental lead, whereas in a fully discharged state the active material for both positive and negative plates may mostly comprise lead sulfate.

Notably, because pure lead is too soft and malleable to form the metallic grid for both positive and negative plates, a lead alloy—such as antimonial lead (PbSb)—is instead used to provide sufficient grid rigidity while also enhancing electrical current flow. Additionally, grids may also be physically structured for improved mechanical strength and improved current flow through different grid patterns. One or two thin “cloths” may also be emplaced over the grid to distribute the weight of the active material more evenly.

While lead—antimony alloys can give the grid structures the necessary rigidity, alternatives such as lead—calcium grid alloys and lead—selenium grid alloys—which themselves still comprise relatively smaller amounts of antimony compared to lead-antimony alloys—may, for certain LAB applications and utilizations, offer metallurgical improvements that provide enhanced grid strength which in turn allows the grid to carry even more weight (i.e., more active material) and thereby enabling the plates to be thicker and improving battery lifespan given the additional active material available, albeit with certain shortcomings of their own which limit their widespread utilization to specialized applications. Regardless, the lead alloys used for the grids are distinct from the lead oxides present in the active material and, in LAB recycling, benefit from being recovered separately.

Stated differently, the electrodes in lead-acid batteries (LABs) typically comprise a metallic frame (“grid”) coated with a lead-based paste (“paste”), the former being constructed from a relatively rigid electro-conductive lead alloy (e.g., antimonial lead) while the latter typically comprises lead oxides and lead sulfates coated over (and strongly adhering to) the exposed surfaces of the lead-alloy grid. In addition, one or two thin “cloths” may be emplaced over the surface(s) of the grid-and-paste combination to promote and maintain an even weight distribution. This assembly, with or without cloths, is broadly referred to herein as an LAB's “grid metallics.”

When recycling LABs, it is desirable to separately recover the lead alloy from the oxidized lead components (e.g., lead paste) of the grid metallics. For example, recycling LABs utilizing high temperature smelting processes—where the lead alloys and lead oxides are smelted together and become intermixed—results in impure lead as output that then requires extensive additional refining and/or alloying processing that are time-consuming and energy intensive. Likewise, recycling LABs utilizing electrolytic processes is similarly problematic because the presence of the lead alloy in a lead slurry (which comprises an electrolyte) interferes with electrolytic efficiencies and may result in impure lead being output.

To address these shortcomings, various implementations disclosed herein are directed to separating lead paste from lead alloy for separate processing to recovery pure elemental lead from the former while also recovering clean lead alloy that can be immediately reutilized in manufacturing new lead acid batteries, for example. For several of these implementations, the lead paste that otherwise adheres to lead alloy grids is chemically loosened via immersion in a proprietary solution and then roughly agitated (or “hammered”) in a rotating baffled barrel-like drum to facilitate complete separation of the lead paste from the broken lead alloy components.

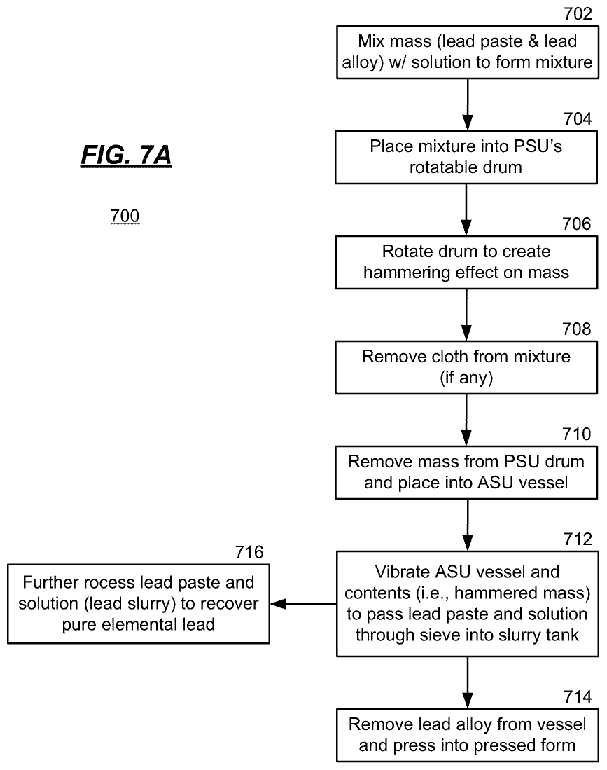

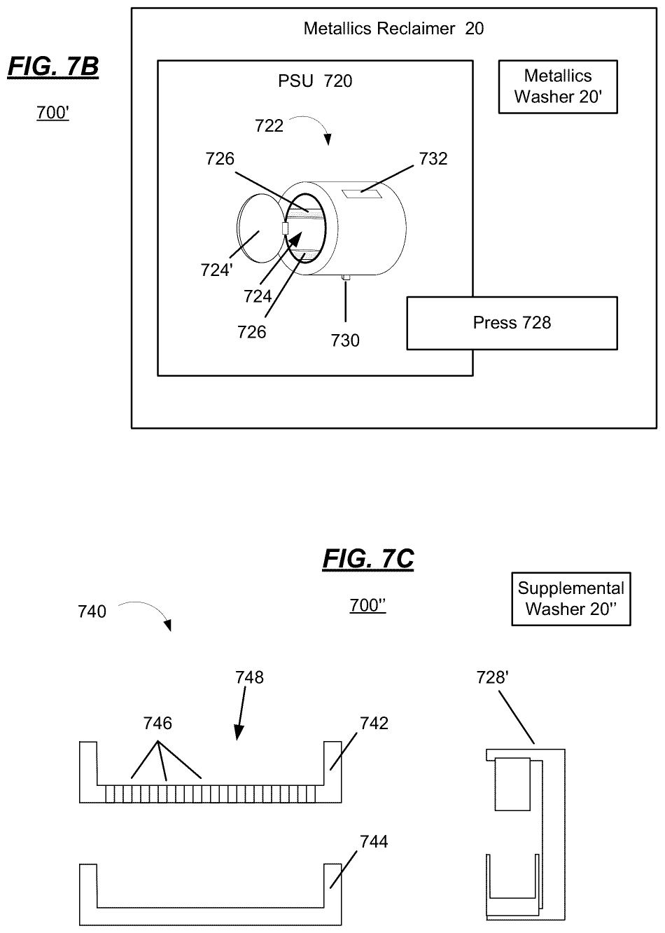

FIG. 7A is a modified process flow diagram 700 illustrating an exemplary process for separating lead paste adhering to broken lead alloy components to facilitate the recovery of elemental lead from the former and clean lead alloy from the latter in a manner representative of various implementations disclosed herein. As illustrated in FIG. 7, and for several implementations disclosed herein, following the battery breaking and recovery/removal of the battery acid, plastics, and separators, the remaining mass of lead paste and grid metallics (“mass”) may be further processed to physically separate the grid metallics (the lead alloy) from the lead paste (the oxidized lead). At 702, the mass is mixed with a proprietary solution comprising proprietary chemicals to create a mass mixture. At 704, the mass mixture is then introduced into the drum of a paste separation unit (PSU). The PSU drum may be a laterally rotatable drum comprising one or more baffles that, when the drum is spun, at 706, create a hammering effect on the mass mixture (“hammering”) to detach the lead paste from the broken lead alloy grid components. The proprietary chemicals in the proprietary solution help loosen the lead paste on the lead grid to facilitate the desired physical separation of the lead paste from the lead alloy during hammering.

After the hammering is complete, any cloth that was included in the mass—which is also divested of any lead paste and lead alloy during the hammering—is removed at 708. For certain implementations, the proprietary solution may enable the lead paste and lead alloy to sink to the bottom of the mixture while the cloth floats to the top of the mixture, thereby permitting the cloth to be removed by skimming it from the top of the mixture. At 710 the hammered mass—which is still a mixture of lead paste, lead alloy, and proprietary solution—is removed from the PSU drum. Notably, although the lead paste no longer adheres to the broken lead alloy components, the lead paste and broken lead alloy components are still mixed together in the proprietary solution.

Also at 710 the hammered mass may then be received by an alloy separation unit (ASU) comprising a holding vessel, a slurry tank vertically positioned under the holding vessel, and an alloy press. The holding vessel may be a vibrating vessel that further comprises a sieve-like floor or base through which the lead paste and proprietary solution may pass, but through which the broken lead alloy components cannot pass. At 712 the vibrating vessel then vibrates the received hammered mass to facilitate gravity-assisted separation of the lead paste and proprietary solution through the sieve-like floor/base and into the slurry tank, whereas the broken lead alloy components remain in the holding vessel.

At 714, the broken (but now clean) lead alloy components-free from lead paste and substantially free of the proprietary solution—may be removed from the holding vessel and pressed by the alloy press to produce clean alloy pellets, said pellets comprising clean lead alloy that is ready for immediate reuse in LAB grid manufacturing and/or other utilizations. Meanwhile, at 716, the lead paste and proprietary solution mixture—now an alloy-free lead slurry—may be removed from the slurry tank and further processed to reclaim pure elemental lead by smelting, electrolytic processing, or other means.

Of course, skilled artisans will understand and appreciate the various alternative implementations that naturally and inherently stem from the foregoing disclosures, including but not limited to: the PSU and ASU operations being separated, conducted independently without the other, in a different order, or iteratively, and/or processing inputs at one that are not derived from nor for use by the other; the PSU substantially draining the proprietary solution and detached lead paste (as lead slurry) from the mixture post-hammering and, for certain implementations, further processing this lead slurry (immediately or eventually) to reclaim pure elemental lead by smelting, electrolytic processing, or other means; separately removing the substantially clean broken lead alloy components from the drum for further processing, where the further processing may be pressing and/or direct utilization as substantially clean lead alloy; utilizing water in the proprietary solution, and/or removing water from the resulting hammered mass, from the drained away mixture of lead paste and/or the proprietary solution in the PSU and/or the ASU, or from the alloy press of the ASU; recycling and reusing the proprietary solution in one or more subsequent masses; the proprietary solution used in the PSU and the ASU are the same or, alternatively, are different for each; that the hammered mass received by the ASU comprises only lead paste and broken grid metallic components but no proprietary solution; the mass (or other input) is washed before processing by the PSU, or the hammered mass (or other input) is washed before processing by the ASU; the slurry from the PSU and the ASU are mixed and processed together to reclaim elemental lead or, alternatively, are processed separately; that the grid metallics are separated from the battery before breaking and processed separately from the other components thereof; and so on and so forth without limit. Moreover, the term “agitating” as used herein is intended to have a broad meaning that includes both hammering and/or vibrating as these terms are disclosed or utilized herein.

FIG. 7B is a modified block diagram 700′ illustrating the major components of an exemplary paste separation unit (PSU) 720 representative of various implementations disclosed herein. As illustrated in FIG. 7B, the PSU 720 may comprise a drum 722 that may be a laterally rotatable drum comprising one or more input/output openings 724 (and one or more doors 724′), through which material may be received or removed, as well as one or more internal baffles 726 that, when the drum 722 is spun (via a rotation motor, not shown), move the mass mixture in a such a manner within the drum 722 so as to create a hammering effect on the mass mixture (“hammering”) to promote the physical detachment of the lead paste from the broken lead alloy grid components within the mixture. In effect, the baffles promote rotation of electrode material and, along with adjustments to rotational speed of the drum, ever-changing portions of the mass will be spun up to the upper portions of the drum (due to rotational inertia assisted by the scooping action of the baffles) and then fall, by action of gravity, downward into other portions of the mass below (the falling solid electrode material hammering the solid electrode material at the bottom).

For certain implementations, the PSU drum 722 may also comprise a hatch 732 (shown closed) through which floating cloth may be removed from the surface of the mass after hammering, said cloth being divested of any lead paste or broken lead alloy components during hammering (the latter sinking to the bottom of the mixture while the cloth floats to the top).

For several implementations, the PSU drum 722 may further comprise a drain 730 through which, after hammering of the mass, the proprietary solution and lead paste components of the mixture are removed from the PSU 722—by effect of gravity, additional rotation of the drum, and/or other means—while the broken lead alloy components are mostly or completely unable to pass through the drain 730 and, being in substantially clean form free from lead paste and the proprietary solution after hammering and draining, may be separately removed from the PSU drum 722 via the one or more input/output openings 724. In some implementations, the PSU 720 may further comprise an alloy press 728 for pressing into pellet form (pellets) the lead alloy removed from the PSU drum 722. Select implementations may also comprise a post-hammer wash 734 (not shown) for washing the lead alloy one last time to remove any residual lead paste or proprietary solution therefrom before pressing said lead alloy into pellets.

For various implementations, the baffles 726 in the drum 722 may be fixed within (and rotate with) the drum 722; for certain other implementations, the baffles 726 may be unfixed and not rotate within the drum 722, rotate differently from the drum 722, rotate in the direction opposite of the drum 722, or exhibit motion different from simple rotation. For implementations having baffles 726 that are fixed within (and rotate with) the drum 722, said baffles 726 may be oriented in several different configurations, may be attached to the inner cylindrical surface of the drum 722, attached to a centrally-running medial axis within the drum 722, or both. Similarly, the drum 722 may have any number of baffles 726, from one to many, oriented in any configuration. In effect, any number and orientation of baffles 726 within the drum 722 that can assist in the agitation and hammering of a mass within the drum when rotated at any speed, low or high, are anticipated as inherent variations of the several different implementations disclosed herein. The PSU 720 may also comprise a press for producing pressed forms (such as pellets) from lead alloy or other metals.

Additionally, for certain select implementations, the interior of the drum 722 may further comprise components necessary for conducting some form of electrolytic processing of the mass in the drum—before, during, and/or after the hammering—to further facilitate separation of the lead paste adhering to the lead alloy, wherein said electrolytic processing may be an adaption of the solid-state electrolysis processes disclosed earlier herein but utilized here for this specific purpose. For such electrolytic processing, the proprietary chemicals in the proprietary solution may act as a supplemental chemical for facilitating such separation, or the supplemental chemical may be different from the proprietary chemical and added to the mixture specifically to promote electrolytic processing.

FIG. 7C is a simplified block diagram 700″ illustrating a side-cut-away view of the major components of an exemplary alloy separation unit (ASU) 740 representative of various implementations disclosed herein. As illustrated in FIG. 7C, the ASU 740 may comprise a holding vessel 742, a slurry tank 744 which may be vertically positioned under the holding vessel 742, and an alloy press 728′. The holding vessel 742 may be a vibrating vessel, that is, a vessel that uses mechanical motion to vibrate, shake, agitate, or otherwise cause motion (“material movement”) in and among the components of a hammered mass or other mixed input comprising more than one distinct component (“mass input”) which herein may be simply referred to as “vibration” and which ostensibly causes lighter components to rise and heavier components to sink, and/or causes liquid components and components suspended in liquid to drain from the holding vessel 744 via gravity-assistance, for example.

To enable such draining, the holding vessel 742 may further comprise a sieve 746, that is, a sieve-like floor or base through which lead paste, proprietary solution, water, and the like, for example, may pass from the holding vessel 742 into the slurry tank 744, but through which broken lead alloy components cannot pass and are removed via a separate output 748 which may also serve as the input for introducing a mass into the holding vessel (as illustrated in the figure), or the output 748 may be also separate from such input.

For certain implementations, the ASU 740 may also comprise a press 728′ for pressing the resultant lead alloy into pellets of lead alloy, effectively removing any residual liquid components that were not earlier drained away. Furthermore, for select implementations, the ASU 740 may also comprise a supplemental washer 20″ for performing one additional wash of the lead alloy resulting from operation of the holding vessel to remove any residual lead alloy, proprietary solution, and so forth from the resultant lead alloy before pressing. These and other variations not specifically described herein will be nonetheless readily appreciated and understood by skilled artisans as inherently disclosed herein.

Additionally, for certain select implementations, the interior of the holding vessel 742 may further comprise components necessary for conducting some form of electrolytic processing of the hammered mass (or other mass or equivalent) located within the drum—preferably before or during the vibrating—to further facilitate separation of the lead paste adhering to the lead alloy, wherein said electrolytic processing may be an adaption of the solid-state electrolysis processes disclosed earlier herein but utilized here for this specific purpose. For such electrolytic processing, the proprietary chemicals in the proprietary solution may act as a supplemental chemical for facilitating such separation, or the supplemental chemical may be different from the proprietary chemical and added to the mixture specifically to promote electrolytic processing.

Notably, for certain alternative implementations, features of the PSU 720 and the ASU 740 may be combined into a single unit, such as where the drum 722 may be the same as the holding vessel 742, where the “vibration” of the ASU 740 is generated by the rotation of the drum 722, where the drain 730 may also comprise a sieve 746, and/or where the alloy press 728 is the also the press 728′ and may also be the same press used after electrolytic processing of the lead paste or other lead slurries. Although described as separate components for convenience, nothing here is intended to limit the PSU 720 and the ASU 740 to separate implementations or components but, instead, any combination of features between the two and/or with features otherwise disclosed herein for other implementations is fully anticipated and hereby explicitly, implicitly, and inherently disclosed.

Accordingly, various implementations disclosed herein are directed to methods and/or systems for separating lead paste adhering to a lead alloy comprising: mixing the lead paste and lead alloy with a solution to form a mixture; agitating the mixture in a manner sufficient to cause the lead paste to no longer physically adhere to the lead alloy; and removing the lead alloy from the mixture. For several such implementations: the agitating may comprise rotational hammering of the mixture; the rotational hammering may be achieved at least in part through use of a rotating drum; the rotating drum may comprise internal baffles that at least in part contribute to the rotational hammering; the rate of rotation of the rotating drum may be maintained within a range that is substantially optimal for achieving the rotational hammering of the mixture, and/or that range may be the rate of rotation at which the portions of the mass in the drum are lifted above a medial axis of the drum and subsequently fall back below the medial axis; the mixture may further comprise cloth adhering to the lead paste, and the agitating causes the cloth to no longer adhere to the lead paste or to the lead alloy; the agitating may comprise vibrating a container within which the mixture is contained, said vibration sufficient to cause material movement within the mixture; the container may comprise a sieve through which the solution and the lead paste may pass but through which the lead alloy may not pass; the vibrating of the container at least in part may facilitate passage of the solution and the lead paste through the sieve. Certain implementations may also comprise pressing the lead alloy into a pressed form. For select implementations, the solution may comprise at least one supplemental chemical that at least in part diminishes adherence of the lead paste to the lead alloy.

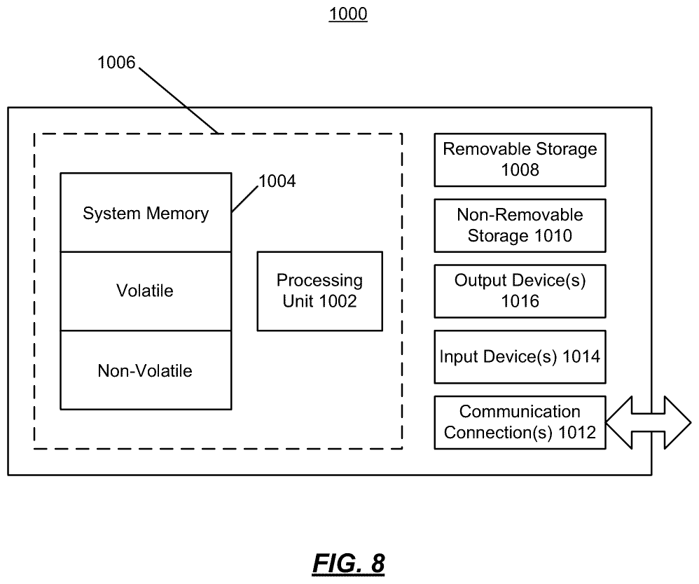

FIG. 8 is a block diagram of an example computing environment that may be used in conjunction with example implementations and aspects such as those disclosed and described with regard to the other figures presented herein and herewith. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, and so forth that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA), an analog-to-digital converter (ADC), or other programmable logic device, discrete gate or transistor logic, discrete hardware components, discrete data acquisition components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

With reference to FIG. 8, an exemplary system for implementing aspects described herein includes a computing device, such as computing device 1000. In a basic configuration, computing device 1000 typically includes at least one processing unit 1002 and memory 1004. Depending on the exact configuration and type of computing device, memory 1004 may be volatile (such as random access memory (RAM)), non-volatile (such as read-only memory (ROM), flash memory, etc.), or some combination of the two. This basic configuration is illustrated in FIG. 8 by dashed line 1006 and may be referred to collectively as the “compute” component.

Computing device 1000 may have additional features/functionality. For example, computing device 1000 may include additional storage (removable and/or non-removable) including, but not limited to, magnetic or optical disks or tape. Such additional storage is illustrated in FIG. 8 by removable storage 1008 and non-removable storage 1010. Computing device 1000 typically includes a variety of computer readable media. Computer readable media can be any available media that can be accessed by device 1000 and may include both volatile and non-volatile media, as well as both removable and non-removable media.

Computer storage media include volatile and non-volatile media, as well as removable and non-removable media, implemented in any method or technology for storage of information such as computer readable instructions, data structures, program modules or other data. Memory 1004, removable storage 1008, and non-removable storage 1010 are all examples of computer storage media. Computer storage media include, but are not limited to, RAM, ROM, electrically erasable program read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store the information and which can be accessed by computing device 1000. Any such computer storage media may be part of computing device 1000.

Computing device 1000 may contain communication connection(s) 1012 that allow the device to communicate with other devices. Computing device 1000 may also have input device(s) 1014 such as a keyboard, mouse, pen, voice input device, touch input device, and so forth. Output device(s) 1016 such as a display, speakers, printer, and so forth may also be included. All these devices are well-known in the art and need not be discussed at length herein. Computing device 1000 may be one of a plurality of computing devices 1000 inter-connected by a network. As may be appreciated, the network may be any appropriate network, each computing device 1000 may be connected thereto by way of communication connection(s) 1012 in any appropriate manner, and each computing device 1000 may communicate with one or more of the other computing devices 1000 in the network in any appropriate manner. For example, the network may be a wired or wireless network within an organization or home or the like, and may include a direct or indirect coupling to an external network such as the Internet or the like. Moreover, PCI, PCIe, and other bus protocols might be utilized for embedding the various implementations described herein into other computing systems.

Interpretation of Disclosures Herein

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high-level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Certain implementations described herein may utilize a cloud operating environment that supports delivering computing, processing, storage, data management, applications, and other functionality as an abstract service rather than as a standalone product of computer hardware, software, etc. Services may be provided by virtual servers that may be implemented as one or more processes on one or more computing devices. In some implementations, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database, etc.) of a device that is actually providing the service (e.g., computing, storage). Users may access cloud services via, for example, a web browser, a thin client, a mobile application, or in other ways. To the extent any physical components of hardware and software are herein described, equivalent functionality provided via a cloud operating environment is also anticipated and disclosed.

Additionally, a controller service may reside in the cloud and may rely on a server or service to perform processing and may rely on a data store or database to store data. While a single server, a single service, a single data store, and a single database may be utilized, multiple instances of servers, services, data stores, and databases may instead reside in the cloud and may, therefore, be used by the controller service. Likewise, various devices may access the controller service in the cloud, and such devices may include (but are not limited to) a computer, a tablet, a laptop computer, a desktop monitor, a television, a personal digital assistant, and a mobile device (e.g., cellular phone, satellite phone, etc.). It is possible that different users at different locations using different devices may access the controller service through different networks or interfaces. In one example, the controller service may be accessed by a mobile device. In another example, portions of controller service may reside on a mobile device. Regardless, controller service may perform actions including, for example, presenting content on a secondary display, presenting an application (e.g., browser) on a secondary display, presenting a cursor on a secondary display, presenting controls on a secondary display, and/or generating a control event in response to an interaction on the mobile device or other service. In specific implementations, the controller service may perform portions of methods described herein.

Anticipated Alternatives

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Moreover, it will be apparent to one skilled in the art that other implementations may be practiced apart from the specific details disclosed above.

The drawings described above and the written description of specific structures and functions below are not presented to limit the scope of what has been invented or the scope of the appended claims. Rather, the drawings and written description are provided to teach any person skilled in the art to make and use the inventions for which patent protection is sought. Those skilled in the art will appreciate that not all features of a commercial implementation of the inventions are described or shown for the sake of clarity and understanding. Skilled artisans will further appreciate that block diagrams herein can represent conceptual views of illustrative circuitry embodying the principles of the technology, and that any flow charts, state transition diagrams, pseudocode, and the like represent various processes which may be embodied in computer readable medium and so executed by a computer or processor, whether or not such computer or processor is explicitly shown. The functions of the various elements including functional blocks may be provided through the use of dedicated electronic hardware as well as electronic circuitry capable of executing computer program instructions in association with appropriate software. Persons of skill in this art will also appreciate that the development of an actual commercial implementation incorporating aspects of the inventions will require numerous implementation-specific decisions to achieve the developer's ultimate goal for the commercial implementation. Such implementation-specific decisions may include, and likely are not limited to, compliance with system-related, business-related, government-related, and other constraints, which may vary by specific implementation, location, and from time to time. While a developer's efforts might be complex and time-consuming in an absolute sense, such efforts would be, nevertheless, a routine undertaking for those of skill in this art having benefit of this disclosure.

It should be understood that the implementations disclosed and taught herein are susceptible to numerous and various modifications and alternative forms. Thus, the use of a singular term, such as, but not limited to, “a” and the like, is not intended as limiting of the number of items. Also, the use of relational terms, such as, but not limited to, “top,” “bottom,” “left,” “right,” “upper,” “lower,” “down,” “up,” “side,” and the like, are used in the written description for clarity in specific reference to the drawings and are not intended to limit the scope of the invention or the appended claims. For particular implementations described with reference to block diagrams and/or operational illustrations of methods, it should be understood that each block of the block diagrams and/or operational illustrations, and combinations of blocks in the block diagrams and/or operational illustrations, may be implemented by analog and/or digital hardware, and/or computer program instructions. Computer program instructions for use with or by the implementations disclosed herein may be written in an object-oriented programming language, conventional procedural programming language, or lower-level code, such as assembly language and/or microcode. The program may be executed entirely on a single processor and/or across multiple processors, as a stand-alone software package or as part of another software package. Such computer program instructions may be provided to a processor of a general-purpose computer, special-purpose computer, ASIC, and/or other programmable data processing system. The executed instructions may also create structures and functions for implementing the actions specified in the mentioned block diagrams and/or operational illustrations. In some alternate implementations, the functions/actions/structures noted in the drawings may occur out of the order noted in the block diagrams and/or operational illustrations. For example, two operations shown as occurring in succession, in fact, may be executed substantially concurrently or the operations may be executed in the reverse order, depending on the functionality/acts/structure involved.

The term “computer-readable instructions” as used above refers to any instructions that may be performed by the processor and/or other components. Similarly, the term “computer-readable medium” refers to any storage medium that may be used to store the computer-readable instructions. Such a medium may take many forms, including, but not limited to, non-volatile media, volatile media, and transmission media. Non-volatile media may include, for example, optical or magnetic disks, such as the storage device. Volatile media may include dynamic memory, such as main memory. Transmission media may include coaxial cables, copper wire, and fiber optics, including wires of the bus. Transmission media may also take the form of acoustic or light waves, such as those generated during radio frequency (RF) and infrared (IR) data communications. Common forms of computer-readable media may include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

In the foregoing description, for purposes of explanation and non-limitation, specific details are set forth—such as particular nodes, functional entities, techniques, protocols, standards, etc.—in order to provide an understanding of the described technology. In other instances, detailed descriptions of well-known methods, devices, techniques, etc. are omitted so as not to obscure the description with unnecessary detail. All statements reciting principles, aspects, embodiments, and implementations, as well as specific examples, are intended to encompass both structural and functional equivalents, and such equivalents include both currently known equivalents as well as equivalents developed in the future, i.e., any elements developed that perform the same function, regardless of structure. While the disclosed implementations have been described with reference to one or more particular implementations, those skilled in the art will recognize that many changes may be made thereto. Therefore, each of the foregoing implementations and obvious variations thereof is contemplated as falling within the spirit and scope of the disclosed implementations, which are set forth in the claims presented below.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

What is claimed:

1. A method for separation of a lead paste adhering to a lead alloy, the method comprising:
mixing the lead paste and lead alloy with a solution to form a mixture;
agitating the mixture in a manner sufficient to cause the lead paste to no longer physically adhere to the lead alloy; and
removing the lead alloy from the mixture.

2. The method of claim 1, wherein the agitating comprises rotational hammering of the mixture.

3. The method of claim 2, wherein the rotational hammering is achieved at least in part through use of a rotating drum.

4. The method of claim 3, wherein the rotating drum comprises internal baffles that at least in part contribute to the rotational hammering.

5. The method of claim 4, wherein a rate of rotation of the rotating drum is maintained within a range that is substantially optimal for achieving the rotational hammering of the mixture.

6. The method of claim 5, wherein the range is the rate of rotation at which the portions of the mass in the drum are lifted above a medial axis of the drum and subsequently fall back below the medial axis.

7. The method of claim 1, wherein mixture further comprises cloth adhering to the lead paste, and wherein the agitating causes the cloth to no longer adhere to the lead paste or to the lead alloy.

8. The method of claim 1, wherein the agitating comprises vibrating a container within which the mixture is contained, said vibration sufficient to cause material movement within the mixture.

9. The method of claim 8, wherein the container comprises a sieve through which the solution and the lead paste may pass but through which the lead alloy may not pass.

10. The method of claim 9, wherein the vibrating of the container at least in part facilitates passage of the solution and the lead paste through the sieve.

11. The method of claim 1, further comprising pressing the lead alloy into a pressed form.

12. The method of claim 1, wherein the solution comprises at least one supplemental chemical that at least in part diminishes adherence of the lead paste to the lead alloy.

13. A system for separation of a lead paste adhering to a lead alloy, the system comprising at least one subsystem capable of:
rotationally hammering a mixture comprising the lead paste, the lead alloy, and a solution, wherein the rotational hammering is performed in a manner sufficient to cause the lead paste to no longer physically adhere to the lead alloy; and
separating the lead alloy from the mixture.

14. The system of claim 13, further comprising at least one subsystem whereby the rotational hammering is achieved at least in part through use of a rotating drum.

15. The system of claim 14, whereby the rotating drum comprises internal baffles that at least in part contribute to the rotational hammering by lifting portions of the mass in the drum above a medial axis of the drum and subsequently letting said portions fall back below the medial axis.

16. The system of claim 15, whereby a rate of rotation of the rotating drum is maintained within a range that is substantially optimal for achieving the rotational hammering of the mixture.

17. The system of claim 13, whereby the agitating comprises vibrating a container within which the mixture is contained, said vibration sufficient to cause material movement within the mixture.

18. The system of claim 17, whereby the container comprises a sieve through which the solution and the lead paste may pass but through which the lead alloy may not pass, and whereby the vibrating of the container at least in part facilitates passage of the solution and the lead paste through the sieve.

19. The system of claim 13, further comprising at least one subsystem capable of pressing the lead alloy into a pressed form.

20. An apparatus for separation of a lead paste adhering to a lead alloy, the apparatus comprising:
a rotating drum for rotationally hammering a mixture comprising the lead paste, the lead alloy, and a solution, wherein the rotational hammering is performed in a manner sufficient to cause the lead paste to no longer physically adhere to the lead alloy;
a vessel for receiving the mixture from the drum and vibrating the mixture sufficient to cause material movement within the mixture to facilitate separation of the lead alloy from the lead paste and the solution.
a press for pressing the lead alloy into a pressed form.
